(19) United States
(12) Patent Application Publication
(10) Pub. No.: US 2011/0060603 A1
(43) Pub. Date: Mar. 10, 2011

(54) Population Adjusted Indexes

(76) Inventors: Christopher C. Capelli, Houston, TX (US); William T. Little, Cypress, TX (US)

(21) Appl. No.: 12/556,449

(22) Filed: Sep. 9, 2009

(51) Int. Cl. G06Q 50/00; G06Q 10/00; G06F 17/30

(52) U.S. Cl. 705/2; 707/741; 707/737; 707/E17.002; 707/E17.046

(57) ABSTRACT

Articles of manufacture including electronic machines including but not limited to computers, computer stations, computing devices, computer systems, software, computer readable memory and other electronic devices adapted to provide an index for a performance characteristic or measure for groups of people or institutions. The index values are risk adjusted to the varying population compositions for groups of people or institutions by comparison to a reference portfolio and are updated in real time to account for the changing constitution of the clusters in the portfolios. Methods of using the disclosed devices include the ability to provide a continuously updated benchmark for the comparison of medical, business or educational performance by providers or practitioners of such services that effect populations of individuals, and that is based on measurable outcomes. Additionally, the methods of using the disclosed devices include the ability to compare the effectiveness of different therapies.

### STATEMENT REGARDING FEDERALLY SPONSORED APPLICATIONS

N/A

### CROSS-REFERENCES TO RELATED APPLICATIONS

N/A

### BACKGROUND

Medical care providers, hospital and practice groups management, payors and insurers, among others have found it difficult t0 evaluate the level and reasonable expense of medical services as applied to a particular group of patients, institutions or practice groups, for example, because of the many variables involved in the health care system. Actuary tables, for example, are based on static, historical data that do not change in real time and do not provide a convenient way to adjust for individual circumstances of a provider's patient population. As medical insurers move to a pay for performance model, it is important that variability in patient populations or patient mix can be taken into account.

A recent publication in the Journal of the American Medical Association: Mehta, et al., JAW, vol. 300[16], pgs. 1897-1903, Oct. 22/29, 2007, discusses the variability in compliance with national guidelines for cardiac care among institutions. In a study to develop performance rankings, the authors chose eight performance measures, and a composite adherence score was calculated for each institution by dividing the sum of all instances of correct care given by the total number of care opportunities. Although this study provided a method of comparing adherence to particular guidelines, it is not easily applied across a broad range of disease conditions or populations because of the number of parameters that must be included, and because of the risk that some important performance criteria may not be included.

Systems and methods for risk-adjusted performance analysis for a specific healthcare test, market or opportunity by evaluating patient outcomes against a real-time benchmark portfolio of patient outcomes have been described by the inventors. The risk-adjusted performance measures were based on financial methods such as the capital asset pricing models (CAPM), single-index model and arbitrage pricing theory methods. In the described systems, rather than examining the financial returns for a portfolio of companies against a financial benchmark, the outcomes for a patient or a portfolio of patients is compared to a benchmark portfolio of patient outcomes. The risk-adjusted performance measures including the Sharpe's measure, Treynor's measure, Jensen's measure and similar analysis tools are then used to compare different healthcare groups. The method has utility in many areas of healthcare including management of healthcare facilities, providing insurance reimbursement to a healthcare facility (e.g., “pay-for-performance”), making investment decisions in the healthcare marketplace and developing dynamic prognostic medical tests.

The disclosure in U.S. Pat Application Publication No. 2007/0154637 describes an approach for comparing one group to another group at a single point in time. However, there are a number of situations where one group wants to track its performance over extended time periods. For example, a healthcare provider may want to know how its performance compares to the previous year or previous quarter. Likewise, the healthcare provider may want to know how its performance compares to other healthcare providers over varying time periods.

U.S. 2007/0154637 describes systems and methods for risk-adjusted performance analysis for a specific healthcare test, market or opportunity by evaluating patient outcomes against a real-time benchmark portfolio of patient outcomes. Using this approach a healthcare provider can obtain an understanding of its performance over time that is relative to a real-time bench-mark portfolio. Likewise, the healthcare provider can compare its performance to other healthcare providers relative to this real-time benchmark portfolio.

Currently, there is a desire by numerous healthcare groups to be able to measure the performance of their healthcare group by comparing themselves to a healthcare index. There are a number of indexes that are currently available including the Medical Consumer Price Index, the Producer Price Index, and the Millimam Healthcare Cost Index, etc. (See US Publication 2007/0011076). While there have been healthcare indexes disclosed in the past, none have been of great help or useful for the healthcare providers to evaluate the performance of their healthcare groups with other healthcare groups. A major problem is that the performance measures or outcomes that are followed over time and compared to these indexes are typically based on values that have not been risk adjusted to reflect changing patient populations or morbidities that make up the index. As a result, generalized use of these indices has not been adopted.

While useful in providing risk-adjusted comparisons, using the approach taught in U.S. 2007/0154637 is problematic if a healthcare provider wants to develop a trend or index. The difficulty arises because the risk-adjustment is to a real-time benchmark that varies over time in terms of its performance values and patient population that compose the benchmark. Unlike the S&P 500 or other “market” portfolios, where the composition of the market portfolio is relatively stable, the real-time benchmark portfolio changes over time causing difficulty in risk-adjusting solely to the patient diversity. Therefore, the risk-adjusted performance values based on these real-time benchmarks do not provide a means to build a trend, index, or risk-adjusted performance value that one can use for the development of an index.

### SUMMARY OF THE INVENTION

This disclosure provides for the first time, the ability to provide a continuously updated benchmark for the comparison of medical, business or educational performance by providers or practitioners of such services that effect populations of individuals, and that is based on measurable outcomes rather than on an attempt to account for all relevant variables. Specifically, this disclosure provides for a healthcare performance index useful for evaluating the performance of a service provider comprising performance index values generated from patient populations that has been transformed to be insensitive to the changing patient-mix or patient diversity allowing the comparison of medical, business or educational performance by providers or practitioners of such services regardless of the populations of individuals being treated by these groups. Additionally, the healthcare performance index are useful for comparing the performance and effectiveness of different therapies.

The present disclosure thus overcomes at least some of the deficiencies of the prior art by providing electronic computing machinery and media as well as methods for producing healthcare indexes that are continuously risk-adjusted for the composition of populations and the morbidity of the populations that compose the indexes. The indexes have multiple uses, including comparison of performance between different groups. The devices and methods of this disclosure provide a new index of outcomes for a portfolio of clusters comprising at least one index value wherein each index value is risk-adjusted to reflect the varying composition of the clusters. This index can be used to compare groups comprising populations of individuals by comparing indexes for each group or comparing groups comprising populations of individuals relative to a market index, or by comparing performance indexes for each group to a market index derived from a model portfolio.

The disclosed indexes are useful for improved pay-for-performance programs, healthcare plans, drug reimbursement programs, etc. Furthermore, the novel indexes can be used as a means to forecast future values and establish financial triggers for financial instruments and insurance linked securities.

The present disclosure can be described in certain embodiments as an electronic system adapted to provide a performance rating index for a healthcare service. The system can include a user interface that includes a processor, a monitor and a user input device. The user interface can thus be a desktop or laptop computer that is either stand alone or connected to a network, either by hard wire or wireless connection. The connection can be to an intranet server, or to an internet server, including, for example, through the World Wide Web. The system can include an electronic connection, either internal or external, to one or more memory storage devices. At least one of the memory storage devices is imprinted with a computer readable database that includes an index data base including at least one numerical indicator of health care performance outcomes and proxy outcomes for a plurality of patients at a plurality of selected time points, wherein the patients are grouped into one or more portfolios and the patients within each portfolio are each assigned to one of a plurality of clusters. The plurality of clusters, each containing data for a number of patients are totaled and averaged at each time point. For example, if the time (t₁-tₙ) is a period of 12 months, then point t₁ is the first month and the average for each cluster is calculated. At time t₂, the second month, for example the average for each cluster is calculated and then added to the average for the first month. In this way a cumulative average is produced, resulting in a line with positive slope when the points are charted. As is known in the art, some spreadsheet programs can be adapted to provide both database storage and mathematical manipulation of the data. The production and use of such a program is contemplated by the present disclosure.

In the described embodiment, a second, or the same memory storage device can include an imprinted, computer readable database, the database including a reference database constructed in a similar configuration as the index database, with the same proxy outcome and including at least all the clusters in the index database. The reference database is chosen to include a large number of members to the individual risk associated with each member becomes statistically insignificant. Alternatively, the computer readable memory can contain only the precalculated cumulative averages for the reference data.

The user interface also includes, or is connected to a processor that is adapted to have imprinted computer readable instructions for calculation of the index using the following relationship:

Index Value(tₙ)=(Σcluster outcome(i)*Q(i))(tₙ)/(Beta(tₙ))

Wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and, in one embodiment, the systematic risk is estimated by correlating the relative volatility of the cumulative proxy outcomes between the cluster portfolio and the reference portfolio.

As described elsewhere herein, outcomes can be any meaningful measure of performance including, but not limited to total cost per patient, number of emergency room visits, complication incidents, mortality, and laboratory measurements. Proxy outcomes can be any outcome that is directly correlated to healthcare performance, including but not limited to total number of days in hospital, total number of outpatient visits, and total monthly prescription expenditures. Other appropriate outcomes and proxy outcomes can also be chosen in the use of the described systems. The patients or subjects are often grouped into clusters within each portfolio by a common diagnosed condition such as a type of cancer or other disease. Exemplary clusters as shown herein include cancers of the uterus, urinary bladder, prostate, pancreas, ovary, non-Hodgkin's lymphoma, lung, leukemia, colorectal, breast, brain, or nervous system.

In certain embodiments of the systems as described, the processor is electronically connected to a computer readable memory device adapted to provide computer readable instructions for calculation of the βₜ using the following relationship for Beta:

β(tₙ)=Cov(rₐ,rₚ)(tₙ)/Var(rₚ)(tₙ)

where rₐ is the rate of change of the index portfolio proxy outcome, and rₚ is the rate of change of the reference portfolio proxy outcome, wherein the variables are determined by calculating a linear regression line of the cumulative outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

In selected cases, beta can also be estimated by direct comparison or division of the index portfolio average proxy outcome by the reference portfolio average proxy outcome. The system can be adapted to utilize those or other methods of determining systematic risk known in the art.

In the use of the described systems, a population is chosen for an index portfolio, such as patients at a particular hospital, patients with a particular disease, etc. that are being treated by a healthcare service provider that is to be evaluated. Often, patients with a first diagnosis such as first cancer that present to a particular hospital or practice group are placed into the database as a portfolio and are then grouped into clusters according to the particular diagnosis or other factors. Depending on the size of the hospital or practice group, the time period for accumulating patients into the portfolio can vary from one month to three months or even up to twelve months if necessary. It is understood, however, that a shorter time is better because that would introduce less variation based on the time of diagnosis. After the clusters are defined and fully populated, the data is accumulated over a defined time period (t₁ to tₙ such as for a year, yielding twelve monthly data points on which to base the index. For ongoing evaluation and index production, a new portfolio can be started each month so the indexes are constantly updated on a monthly basis. It is also understood that the monthly time periods could be lengthened or shortened to weekly or even daily in certain circumstances.

In certain preferred embodiments the present disclosure can also be described as an electronic system for providing an index for a healthcare service including a server computer connectable to a user interface, in which the server includes an electronic connection to one or more memory storage devices, wherein at least one memory storage device comprises an imprinted computer readable database comprising at least one numerical indicator of health care performance outcomes and proxy outcomes for a plurality of patients assigned to an index portfolio, wherein the patients are grouped into one or more portfolios and the patients within each portfolio are each assigned to one of a plurality of clusters, and wherein the database includes the cumulative average outcome for each cluster at a plurality of selected time points, and wherein at least one memory storage device comprises an imprinted, computer readable database comprising cumulative average proxy outcomes for a plurality of clusters of a reference portfolio at the equivalent time points as the index portfolio data; a computer readable memory device connected to or contained in the server and adapted to comprise computer readable instructions for calculation of the index using the following relationship:

Index Value(tₙ)=(Σcluster outcome(i)*Q(i))(tₙ)/Beta(tₙ))

Wherein, cluster outcome (i) is the proxy outcome value for cluster (i) in the cluster portfolio at time (tₙ); Q(i) is the segment weight of cluster (i) in the cluster portfolio at time (tₙ); and Beta is the systematic risk at time (tₙ) and the systematic risk that is estimated by comparing the correlated relative volatility of the cumulative proxy outcomes between the cluster portfolio and the reference portfolio. The server can optionally be connected to a user interface either through an intranet or interne' connection.

In yet another embodiment the disclosure includes an article of manufacture that includes a computer usable medium having a structure including a computer readable program code embodied therein for calculating a performance index using the following relationship:

Index Value(tₙ)=cluster outcome(i)*Q(i))(tₙ)/Beta(tₙ))

Wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing the cluster portfolio to the reference portfolio for a defined outcome, measured over a defined time period.

The present disclosure also includes processes as described herein that are tied to the described electronic systems. Such processes include but are not limited to processes for evaluating the performance of a service provider including the steps of calculating a performance index at a plurality of time points for the service provider; risk adjusting the performance indexes by dividing each index by a calculated β derived by comparison of the index proxy outcome to a reference portfolio proxy outcome; and comparing the performance index of the service provider to the risk adjusted performance index of a model portfolio or to the risk adjusted index of another index portfolio.

The described processes can be used to provide an index for a medical service provider such as a hospital, a physician group, or a physician. Likewise, the described processes can provide an index for an educational service provider such as a school, a school system, an educational department in a school system or a teacher, for example. Performance outcomes for educational providers can include student grades in a course, student grades on an exam, number of disciplinary actions, and student graduation rate.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic representation of two cluster portfolios, exemplified as healthcare providers A and B. Within each portfolio are a number of clusters of patients Cluster 1 through Cluster n. As shown, the portfolios can contain a different number of clusters.

FIG. 2 is a flow diagram demonstrating the general approach in risk adjusting an index value for a portfolio.

FIG. 3 is a schematic outline of the data requirements.

FIG. 4A is a diagram of a method of creating an index based on the trailing 12 month data, in which new groups of patients are formed each month.

FIG. 4B is an example of a chart of reference proxy outcome data for a reference portfolio in which clusters are defined by types of cancers.

FIG. 4C is an example of a chart of proxy outcome data for an index portfolio in which clusters are defined by types of cancer.

FIG. 4D is a graph of the cumulative proxy outcome data (average days hospitalized per patient) from the reference and cluster portfolios.

FIG. 4E is a graph of the linear regression curve derived from cumulative average days hospitalized per patient from the reference and patient portfolios.

FIG. 5A is a schematic representation of the basics of index construction, using linear regression to derive a beta used to adjust an index value for a part of a series of time points.

FIG. 5B is a detailed flow diagram for risk-adjusting an index value used in the construction of an index.

FIG. 5C is a flow diagram for the collection and analysis of proxy outcome data.

FIG. 5D is a flow diagram for the collection and analysis of cluster outcome data.

FIG. 6 is a diagram illustrating the steps in direct comparison between three portfolios.

FIG. 7 is a diagram illustrating the steps in comparison of two portfolios relative to a market index.

FIG. 8 is a graph representing the unadjusted index data (average total healthcare cost per patient) for a cluster portfolio, including the trend line.

FIG. 9 is a chart demonstrating the changing composition of the percentage of patients in the clusters for a specific portfolio over time.

FIG. 10 is an example of the data used in risk-adjusting an Index Value.

FIG. 11 is a graph showing the 90 day adjusted and unadjusted index data and trend lines for average total health care cost per patient.

FIG. 12 is a chart of cluster compositions (type of cancers) for MD Groups portfolios.

FIG. 13 is a graph of the unadjusted data for average total pharmaceutical cost per patient from ten MD Groups in which one MD Group has the costs artificially adjusted upwardly.

FIG. 14 is a graph of the MD Groups shown in FIG. 13 with risk adjusted data, showing the clear outlier with a high average total pharmaceutical cost per patient.

FIG. 15 is a graph of unadjusted data for total growth in average total healthcare cost per patient for a series of ten hypothetical oncology healthcare groups.

FIG. 16 is a graph of risk adjusted data for total growth in average total cost per patient for the series of ten hypothetical oncology healthcare groups shown in FIG. 15.

### DETAILED DESCRIPTION OF THE INVENTION

The present disclosure provides articles of manufacture including electronic machines including but not limited to computers, computer stations, computing devices, computer systems, computer networks, computer readable devices with embedded Software, computer readable memory and other electronic devices adapted to provide an index for a performance characteristic or measure for groups of people or institutions. The index values are risk adjusted for varying patient populations by comparison to a reference portfolio containing clusters in which individual risk is statistically insignificant, and are updated in real time to account for the changing constitution of the clusters in the portfolios.

The present disclosure is based, at least in part, on a number of unexpected and surprising insights that made providing a performance rating index for healthcare groups feasible by transforming an index of performance outcomes so as to be insensitive to varying patient-mix compositions. The first insight is that patients treated by each healthcare group or physician group can be treated as a ‘portfolio’. That is to say, each healthcare provider's practice is a portfolio wherein the patients represent assets and these assets can be segmented into clusters wherein the clusters are segmented based on a disease, complex illness or other factor (i.e., patient's chronic illnesses, number of chronic illnesses, age, weight, socioeconomic class, combination of the above and others). In one preferred embodiment, the clusters share a characteristic macro-factor such as morbidity. As used herein, macro factors are the ones that affect the cluster portfolio based on a disease or complex illness indirectly and include such factors as population morbidity, age, race, socioeconomic level, occupation, etc. For example, a portfolio of patients with different types of cancers would be segmented on the type of cancer wherein each type of cancer has a characteristic morbidity (e.g. patients with lung cancer have a higher morbidity than patients with stage 1 breast cancer).

The second insight is that performance of a healthcare providers' portfolios can be measured in a manner analogous to using modern Financial Portfolio Theory and CAPM (i.e., capital asset pricing methods) as developed by Markowitz, Sharp, Treynor and others in the 1950s-1970s. In Financial Portfolio Theory, the measurement of performance for a portfolio can be measured by its financial returns. For financial portfolios, these outcomes can be weighted in calculating an index such as the S&P 500, for example, by the capitalization of each company (analogous to a cluster in a portfolio). In healthcare, the performance outcomes of interest may include a number of factors such as the total healthcare costs per treating a patient, total pharmaceutical costs per patient, total days hospitalized, etc. The portfolio outcome is equal to the sum of the weighted outcomes of patient's outcomes. Rather than market capitalization, clusters are weighted by the number of patients in each cluster.

However, comparing the performance outcomes of different portfolios or healthcare groups is complicated because at each time point, the patient-mix for any specific portfolio changes. As a result, for each time period, all healthcare portfolios are in essence new portfolios. Thus comparing different portfolios can only be done after first risk-adjusting the performance outcome for each portfolio's risk resulting from the patient-mix. Prior to the present disclosure, however, there has been no feasible way to measure portfolio risk for portfolios consisting of varying populations of individuals.

In the financial models (i.e., CAPM, single-factor model, etc.) used in Modern Portfolio Theory, risk is classified as being derived from systematic risk factors or company-specific risk factors. However, in a portfolio of different assets, the specific risks are diversified out, or individual risks become statistically insignificant due to diversity of the assets. As a result, the portfolio risk comprises only the systematic risk.

In the calculation of the portfolio risk for portfolios consisting of varying populations, the present disclosure arises from a key insight that a portfolio comprising a large enough number of patients will be well diversified, therefore patient-specific risks can be ignored. Only systematic risks remain. For a portfolio of patient clusters based on a disease or complex illness, one systematic risk is the morbidity of the patients having that disease or complex illness relative to the patient population as a whole or in a reference portfolio. Therefore, the performance for healthcare provider's portfolio can be compared to other portfolios by adjusting performance measurements for portfolio risk caused by the changing patient-mix at each time point. In other words, by adjusting for systematic risk, the difference in the physician portfolio performance compared to other portfolio performances is due to the care provided by the physician and not due to the composition of the patient population in each portfolio.

Finally, with a specific physician group's portfolio risk-adjusted to reflect the patient-mix, the performance of that physician group's portfolio can be compared directly to other physician groups or relative to benchmark or “market” portfolios that have been risk-adjusted to reflect their patient-mix. This changes current ‘apples to oranges’ performance comparison of healthcare groups into a useful and practical ‘apples to apples’ performance comparison.

### Assumptions for Using Population Adjusted Indexes for Chronic or Complex Illnesses

This disclosure provides for the first time, the ability to provide a transformed index by risk-adjusting to the patient-mix so as to be useful for the comparison of medical, business or educational performance by providers or practitioners. Assumptions for using population adjusted indexes of this disclosure for healthcare groups that have portfolios consisting of patients with chronic (i.e., heart disease, diabetes, COPD, etc.) or complex illnesses (e.g. cancers) are as follows:
Physician practices will hold a portfolio of patients that duplicate representation of patients seen in the market portfolio. For example, a medical generalists (i.e., Family Practitioners, Internist, etc.), will have patients in their practice with heart disease, lung disease, diabetes, etc.
Physicians who treat patients with chronic or complex diseases follow current medical practices. Current medical practice is defined by how the majority of physicians are treating patients with specific chronic or complex diseases. These practices are typically based on accepted approaches or clinical protocols as published in the medical literature or presented at medical conferences. The methods of this disclosure assume all physicians have access to current medical guidelines. Instability of a chronic or complex patient is most often tied to deviations from accepted clinical protocol or non-compliance.
Physicians are rational and seek to improve chronic or complex diseases in the most effective manner (i.e., Physicians are rational mean-variance minimizers). For example, a physician will not prescribe 3 hypertensive medications when a single antihypertensive medical is effective.
Selected proxy outcomes (i.e., prescription prevalence, prescription intensity, office visits, days hospitalized, healthcare costs, mortality rate, etc.) for chronic or complex diseases follow a mean-variance relationship. The greater the risk (i.e., morbidity, age, obesity, socioeconomic status, etc.) for a patient, the higher the proxy outcome. For example, the morbidity of a cluster of patients increases with an increase number of chronic or complex illnesses for that cluster. As a result, the prevalence and intensity of prescriptions increases Thus, prevalence and intensity of prescriptions can be used as a proxy outcome.
The variance of the proxy outcome relative to the reference portfolio is an adequate measurement of portfolio risk resulting from the patient-mix.
The “risk-free” rate is equal to zero for selected proxies (i.e., prescription prevalence, prescription intensity, days hospitalized, healthcare costs, etc.) associated with chronic or complex diseases. That is to say, a healthy population would have no prescriptions or days hospitalized, etc.

### Requirements for Portfolio Risk Calculation

To analyze the portfolio risk secondary to varying patient-mix for a healthcare group requires a tremendous amount of data and calculations. Specifically, estimating physician practice cluster portfolio risk using standard techniques typically requires a huge number of estimates of covariance's between all pairs of patients in the physician practice portfolio which is impractical and overwhelming. As an example, for a physician practice that sees 500 patients, the number of estimates of covariance required is 124,750 [(n²−n)/2]. For a healthcare group that has multiple physicians and sees 20,000 patients, the number of estimates of covariance required is 199,990,000 [(n²−n)/2]

The present disclosure provides specific electronic devices that are adapted for use in overcoming this problem of deriving portfolio risk using a huge number of estimates of covariance by estimating the portfolio risk in a simpler way. The risk is estimated by comparing the correlated relative volatility of the cumulative proxy outcomes of the physician's cluster portfolio to cumulative proxy outcomes of a reference portfolio. Estimating the cluster portfolio's systematic risk using the approaches described herein drastically reduces the necessary calculations because the covariance between proxy outcomes for the patients and patient clusters derives only from the common factor consisting of the proxy outcome for the reference portfolio. As a result, a healthcare group that has multiple physicians and sees 20,000 patients will need only 20,000 estimates of covariance (versus 199,990,000 estimates of covariance as discussed above).

For a healthcare payor or a Pharmaceutical Benefits Management Company that may have tens of millions of patients, estimating the portfolio risk in order to compare performance between healthcare groups using the current approaches is impractical. For example, a healthcare insurer with 20 million patients in different healthcare groups would need an approximately 400,000 billion covariance calculations for each time point. However, using the approach described in this disclosure, less than 60 million calculations would need to undertaken per time point.

The present disclosure provides in certain embodiments, therefore, electronic systems comprising:

a server computer connectable to a user interface, in which the server includes an electronic connection to one or more memory storage devices, wherein at least one memory storage device comprises an imprinted computer readable database comprising at least one numerical indicator of health care performance outcomes and proxy outcomes for a plurality of patients assigned to an index portfolio, wherein the patients are grouped into one or more portfolios and the patients within each portfolio are each assigned to one of a plurality of clusters, and wherein the database includes the cumulative average outcome for each cluster at a plurality of selected time points, and wherein at: least one memory storage device comprises an imprinted, computer readable database comprising cumulative average proxy outcomes for a plurality of clusters of a reference portfolio at the equivalent time points as the index portfolio data a computer readable memory device connected to or contained in the server and adapted to comprise computer readable instructions for calculation of the index using the following relationship:

Index Value(tₙ)=(Σcluster outcome(i)*Q(i))(tₙ)/(Beta(tₙ))

Wherein, cluster outcome (i) is the proxy outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing the correlated relative volatility of the cumulative proxy outcomes between the cluster portfolio and the reference portfolio.

Unless otherwise indicated, all terms used herein are meant to convey their ordinary meanings as understood in the art. For further clarity, however, certain terms are used herein as stated below.

The term “cluster” means a group of things or persons close together or related in some way as in patients with a common characteristic such as a disease or diagnosis. More specifically, the term “cluster” means the grouping of data into subsets (clusters), so that the data in each subset are derived from subjects that share some common trait. Examples of clusters include patient age, patient gender, type of chronic illness, number of chronic illnesses, type of complex disease such as cancer type (and/or stage), socioeconomic background, etc.

Outcome data, performance outcome or cluster outcome data is the information that will be used to compare the different healthcare groups over the specified Time Period (tₙ). Outcome data can include any number of outcomes for performance comparison purposes including (but not limited to): Total healthcare costs per patient, total pharmaceutical healthcare costs per patient, days hospitalized, office visits, mortality rate, readmission rates, etc.

Proxy outcome data is the information that is used to estimate the systematic risk or beta. The proxy outcome data can be the same data as the outcome data (i.e., total healthcare costs per patient, total pharmaceutical healthcare costs per patient, days hospitalized, office visits, mortality rate, etc.) or separate data. The key requirement for selecting the type of outcome data that should be used as proxy outcome data is that the outcome data directly correlates with the healthcare performance for the portfolio cluster. That is to say, the proxy outcomes exhibit a mean-variance relationship with the healthcare performance for the portfolio cluster. Two examples of mean-variance relationships include:
As patient morbidity increases (variance), the number of office visits increases (mean);
As patient age increases (variance), the number of monthly prescriptions increases (mean).

Segmentation data or cluster data refers to data that is used to separate the patients into clusters that will be used in forming the healthcare portfolios. The segmentation data is any data that can be used to separate the patient into different clusters including patient's identification number, age, weight, socioeconomic background, treating physician, etc.

An “index” is a number or formula expressing some property, ratio; etc., of some chosen parameter, indicated such as: index of growth; index of intelligence, index of health care costs, etc.

A patient portfolio is a collection or group of patients treated by a healthcare institution, clinic, or a private physician (collectively “healthcare system”). More specifically, a patient portfolio is a portfolio wherein the patients represent assets and these assets can be segmented into clusters wherein the clusters are segmented based on a disease, complex illness or other factor (i.e., patient's chronic illnesses, number of chronic illnesses, age, weight, socioeconomic class, combination of the above and others) that share a characteristic morbidity. For example, a portfolio of patients with different types of cancer would be segmented on the type of cancer because each type of cancer has a characteristic morbidity (e.g. patients with lung cancer have a higher morbidity than patients with stage 1 breast cancer.). A patient portfolio may also be referred to herein as a cluster portfolio or index portfolio.

A reference portfolio is defined as a portfolio of subjects divided into one or more clusters, and in which the number of members of each cluster is large enough that the specific risk of the individuals is statistically insignificant. A reference portfolio typically consists of the same cluster segmentation or cluster groupings as the market portfolio and is used to reflect and represent the patient-mix of the broad market but at a defined time period (t₀). For example, the market portfolio for the year 2007 may be used at the reference portfolio when estimating the systematic risk for cluster portfolios for the years 2007, 2008, 2009, etc.. The reference portfolio is set and only changes with a major change in the marketplace. That is to say, the reference portfolio once established is used in all future estimations of systematic risk for cluster portfolios only changing occasionally.

A benchmark or market portfolio is a portfolio that consists of the potential patient clusters that reflect and represent the total patient clusters. The risk-adjusted benchmark portfolio is used in comparing different healthcare portfolios.

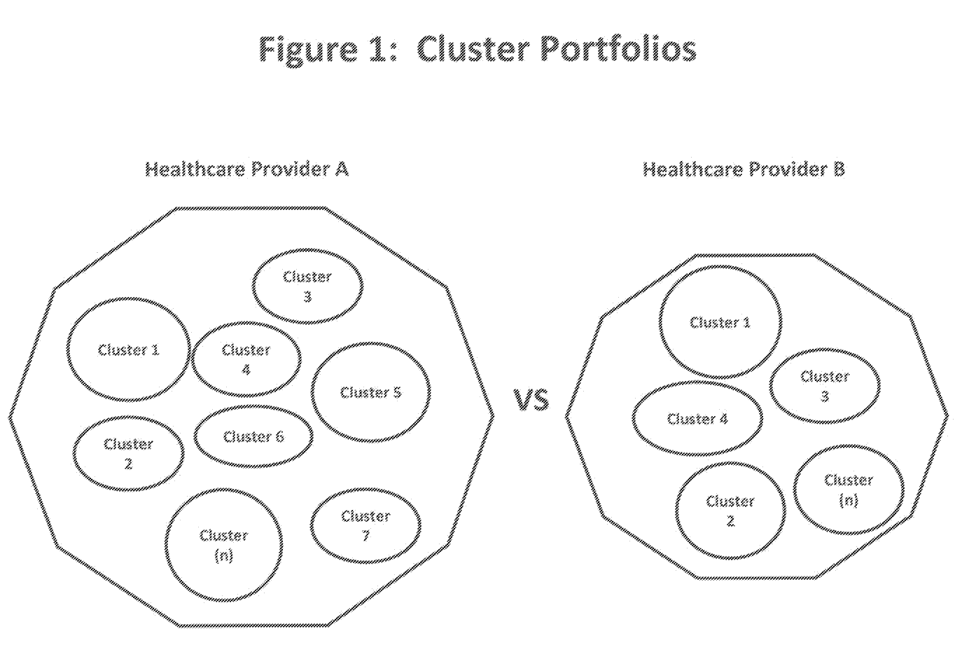

The term “groups” refers to a portfolio of clusters or cluster portfolio. Groups can be used to mean any defined population such as a healthcare provider (i.e., hospital, physician group, etc.), educational group (i.e., school system, school or teacher), etc. FIG. 1 provides a schematic representation of two groups, each consisting of a portfolio of clusters. In the first group (i.e., Hospital Provider A), the portfolio consists of at least 8 clusters. In the second group (i.e., Hospital Provider B), the portfolio consists of at least 5 clusters.

As can be seen in FIG. 1 there can be a different number of clusters within each group and there can also be a different size for each cluster. In an example in which the groups are two hospitals, a cluster can be defined as a group of patients who have been diagnosed with a specific disease (i.e., a cluster of patients with lung cancer, a cluster of patients with colorectal cancer, etc.). As a result, one would expect the clusters to vary in size depending on the disease population for each hospital at each time. Given that the cluster portfolios between the two hospitals are so different, making meaningful comparisons between such hospitals has been difficult. However the present disclosure provides a simple and straightforward index that accomplishes the desired comparison.

Beta is a measure of systematic risk. The systematic risk is a non-diversifiable risk attributable to common macroeconomic and/or macro-factors; e.g., risk factors that are common to the entire economy, disease state or patient cluster. For example, for a cluster portfolio based on a disease or complex illness, one systematic risk is the morbidity of the patients having that disease or complex illness relative to the population as a whole or to patients in a reference portfolio.

Non-systemic risk is a risk that is unique to an individual asset or patient that can be eliminated by diversification. It represents the component of an asset's return or patient's outcome that is uncorrelated with a market or benchmark portfolio. Non-systematic risk is used interchangeably herein with specific risk.

Total risk refers to the sum of the specific and systematic.

Real-time refers to a database, information, etc. that is updated on a periodic basis. This periodic basis can be has long as one year and as short as less than a second.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” or “the” may mean a singular object or element, or it may mean a plurality, or one or more of such objects or elements.

### Index Mathematics

The S&P 500 index and other well known financial indexes use indexes that are weighted to the capital of companies wherein the weights change only infrequently. However, the index mathematics using defined populations of groups or entities that do not change over time would be inadequate in developing an index of outcomes for a portfolio of clusters that have varying composition of the clusters. For example, the XXX Mortality Index provided by Goldman Sachs is an index of mortality of a defined group of individuals. Every few years a new index is begun to reflect a new group of individuals. This approach, however, is limited in that it requires indexes with durations whose time span usefulness is tied to a specific, static group of individuals and not a varying population.

The indexes of this disclosure are weighted to the defined ‘cluster’ such as disease segment, patient population, pupil population, physician groups, etc. Risk-adjusting the index only to account for the changing cluster weights of the portfolio is straight forward and is easily accomplished using only the number of patients in each cluster. However, risk-adjusting a healthcare index in a simple way that accounts for the changing cluster weights and varying patient morbidity has not been accomplished up to now.

This disclosure provides for the first time, a healthcare performance index useful for evaluating the performance of a service provider comprising performance index values generated from patient populations that has been transformed to be insensitive to the changing patient-mix or patient diversity of the patient portfolio allowing the comparison of medical, business or educational performance by providers or practitioners of such services regardless of the populations of individuals being treated by these groups.

More specifically, the disclosure provides for the first time a healthcare performance index useful for evaluating the performance of a service provider that has been transformed to be insensitive to the patient-mix comprising at least one numerical indicator of health care performance outcomes at a plurality of time points that has been risk adjusted for the patient mix;

wherein the performance index comprises at least one numerical indicator of health care performance outcomes and proxy outcomes for a plurality of patients at a plurality of selected time points, wherein the patients are grouped into one or more portfolios and the patients within each portfolio are each assigned to one of a plurality of clusters;

wherein the said outcomes and proxy outcomes are averaged for each cluster at each time point to produce a cluster outcome and proxy cluster outcome, and said outcomes are added to the average at each time point (t₁-tₙ) to obtain the cumulative average from the previous time point;

wherein said risk adjusted performance index value is calculated using following relationship:

Index Value(tₙ)=(Σcluster outcome(i)*Q(i))(tₙ)/Beta(tₙ))

wherein, cluster outcome (i) is the outcome value or proxy outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing proxy outcomes between the cluster portfolio to the reference portfolio;

wherein said reference portfolio comprises at least one numerical indicator of health care performance proxy outcome that is the same proxy outcome as at least one proxy outcome in the index database for the equivalent time points as in the index database, wherein the outcome at each time point (t₁-tₙ) is added to the cumulative outcome from the previous time point.

The present disclosure is based at least in part on novel methods of providing indexes based on clusters of continuously varying populations

The ability to transform a healthcare performance index so that it is insensitive to varying patient-mix compositions that have varying macro-factors, such as varying morbidity, now permits the development of new indexes that have utility in fields that traditionally have not had indexes. Furthermore, the availability of indexes based on clusters of populations now provides new ways to measure and compare different groups in a simplified fashion.

### Index Construction

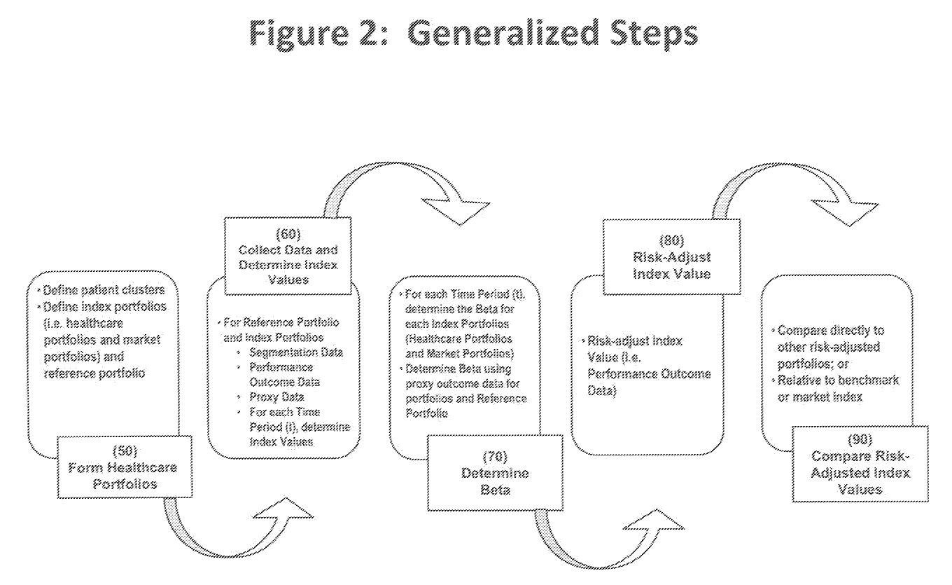

The general method of forming a healthcare performance index useful for evaluating the performance of a service provider is illustrated in FIG. 2 and consists of five major parts: Form healthcare portfolio (50), collect data to determine the index Values(60), and determine Beta (70), risk-adjust Index Value (80) and compare risk-adjusted index values (90). Once the Index Value has been risk-adjusted, it can be compared directly to other healthcare portfolios (that have also been risk-adjusted) or compare to other healthcare portfolios relative to a market portfolio (i.e., each portfolio which has been also been risk-adjusted).

The first-step in the general approach to this disclosure is to form portfolios of patients (50) consisting of both the index portfolios (i.e. market portfolio and cluster portfolio) and the reference portfolio. In one embodiment, each healthcare group or physician group can be treated as a ‘portfolio’. That is to say, each healthcare provider's practice is a portfolio wherein the patients represent assets and these assets can be segmented into clusters wherein the clusters are segmented based on a disease, complex illness or other factor (i.e., patient's chronic illnesses, number of chronic illnesses, age, weight, socioeconomic class, combination of the above and others) that share a characteristic macro-factor such as morbidity. For example, a portfolio of patients with different types of cancers would be segmented based on the type of cancer because each type of cancer has a characteristic morbidity (e.g. patients with lung cancer have a higher morbidity than patients with stage 1 breast cancer.). A critical aspect to defining clusters for a portfolio is that there exists an easily measured proxy outcome that can be correlated to the macro-factor of the cluster type. Examples of useful clusters for portfolio design, macro-factor and the a representative proxy outcome is as follows:

| Cluster Type | Macro-factor | Proxy Outcome |
|---|---|---|
| Cancer Types (lung, breast, | Morbidity | Days hospitalized, |
| colorectal, etc.) | | office visits, |
| | | disease recurrence, etc |
| Cancer Severity (i.e., lung | Morbidity | Office visits, |
| cancer stage 1, lung cancer | | days hospitalized, |
| stage 2, etc.) | | prescription utilization, etc |
| Chronic illness (i.e., heart | Morbidity | Office visits, |
| disease, COPD, diabetes, etc.) | | days hospitalized, |
| | | pescription |
| | | utilization, etc |

The market portfolio is the representative portfolio for the entire marketplace. The market portfolio consists of all the potential patient clusters in the marketplace that will be used in comparing different healthcare portfolios. For example, for comparing oncology healthcare groups, the market portfolio may consist of clusters of patients having the 10 most prevalent cancers. In evaluating different healthcare groups, each healthcare or index portfolio is evaluated based on the clusters that make up the market portfolio. The healthcare portfolio does not need to contain all the clusters that compose the market portfolio. However, the healthcare portfolio cannot include clusters that are not part of the market portfolio. For example, if the market portfolio consists of clusters comprising breast, colorectal, leukemia, liver and lung cancer, the healthcare portfolio can consist of clusters comprising breast, colorectal and leukemia cancers. However, the healthcare portfolio cannot consist of cluster comprising breast, colorectal, leukemia and bladder cancer because the market portfolio does not contain the cluster comprising bladder cancer.

The reference portfolio typically consists of the same cluster segmentation or cluster groupings as the market portfolio but at a set period of time. For example, the market portfolio for the year 2007 may be used to generate the reference portfolio that is used in estimating the systematic risk for cluster portfolios for different time periods (i.e., 2007, 2008, 2009, etc.) The reference portfolio is set and is not modified unless there has been a major change in the marketplace. For example, a major cancer may be eliminated through a cure for said cancer (i.e., the elimination of cervical cancer because of vaccination). If the reference portfolio is adjusted, it should only be done only periodically (i.e. every 3-8 years) or only as often as there is a significant change.

Data collection (60) is the second step in the general approach of this disclosure. Data collection is done by interfacing with databases containing relevant medical or individual data using an electronic system comprising:

a user interface comprising a processor, a monitor and a user input device;

an electronic connection to one or more memory storage devices, wherein the memory storage devices comprise an imprinted database comprising at least one numerical indicator of health care performance outcomes and proxy outcomes for a plurality of patients, wherein the patients are grouped into one or more portfolios and the patients within each portfolio are each assigned to one of a plurality of clusters, and wherein the database includes the average outcome for each cluster at a plurality of selected time points;

a computer readable memory device connected to the processor adapted to comprise computer readable instructions for calculation of the patient-mix risk-adjusted index values.

For evaluation of healthcare providers, the databases that are interfaced include the databases containing medical information such as the patients ID, age, diagnosis, etc. Other databases can be used for this disclosure including databases consisting of pharmaceutical utilization by the patient. These databases typically reside with the pharmaceutical benefit management companies and health insurance companies.

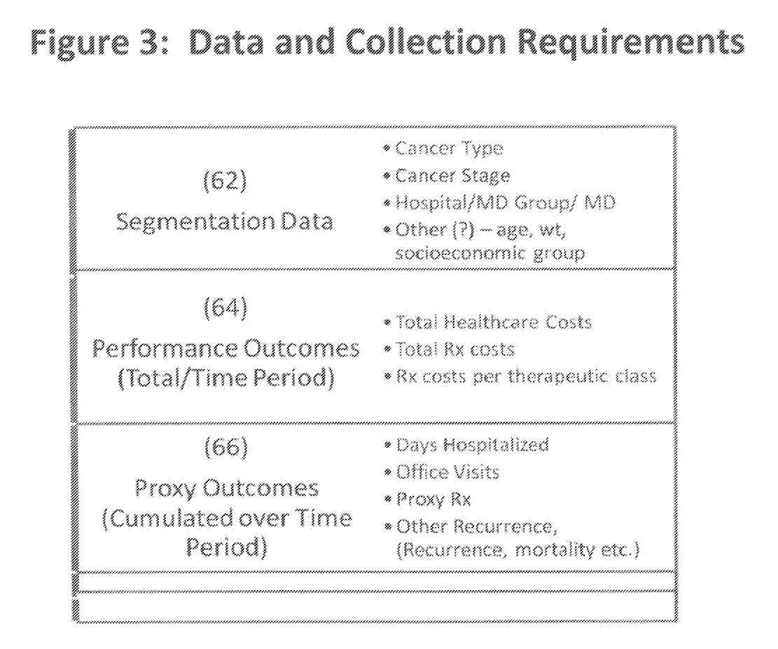

In one embodiment, FIG. 3 provides an illustration of data groups that can be collected when comparing the performance of difference oncology groups using the methods of this disclosure. For the construction of a cluster or market portfolio, segmentation data and cluster outcome data (62) is collected. The segmentation data (62) is used to separate the patients into clusters that will be used in forming the healthcare portfolios. The segmentation data (62) is any data that can be used to separate the patients into clusters including patient's identification number, age, weight, socioeconomic background, treating physician, etc. For example, the segmentation data that would be useful in evaluating different oncology healthcare groups would include the patients ID, age, cancer type, cancer stage, treating physician, date of diagnosis.

To construct an index for each portfolio, performance outcome data (64) and proxy outcome data (66) are required. As discussed previously, performance outcome data (64) is the information that will be used to compare, after risk-adjusting for the patient-mix, the different healthcare groups for a specified time period (tₙ). As an example, performance outcome data can include one or more of the following for performance comparisons: average total healthcare costs per patient, average total pharmaceutical healthcare costs per patient, days hospitalized, office visits, mortality rate, etc. As an illustration, if comparing different oncology healthcare groups, one outcome data of interest would be the average total healthcare costs per patient for treating patients diagnosed with cancer over a 1 year time period.

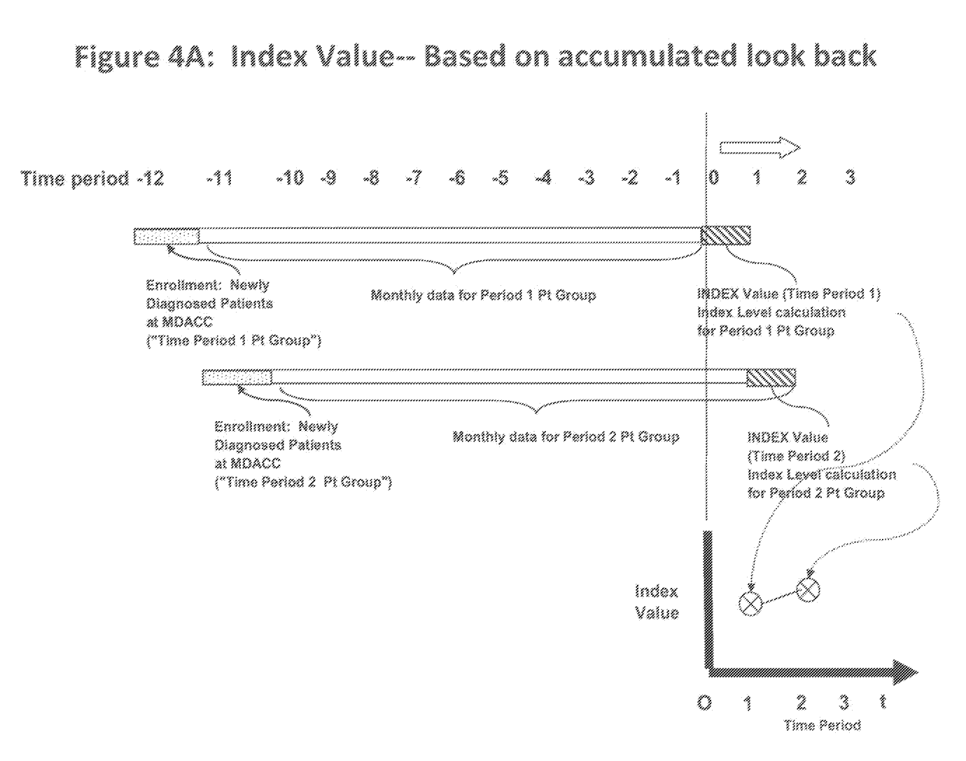

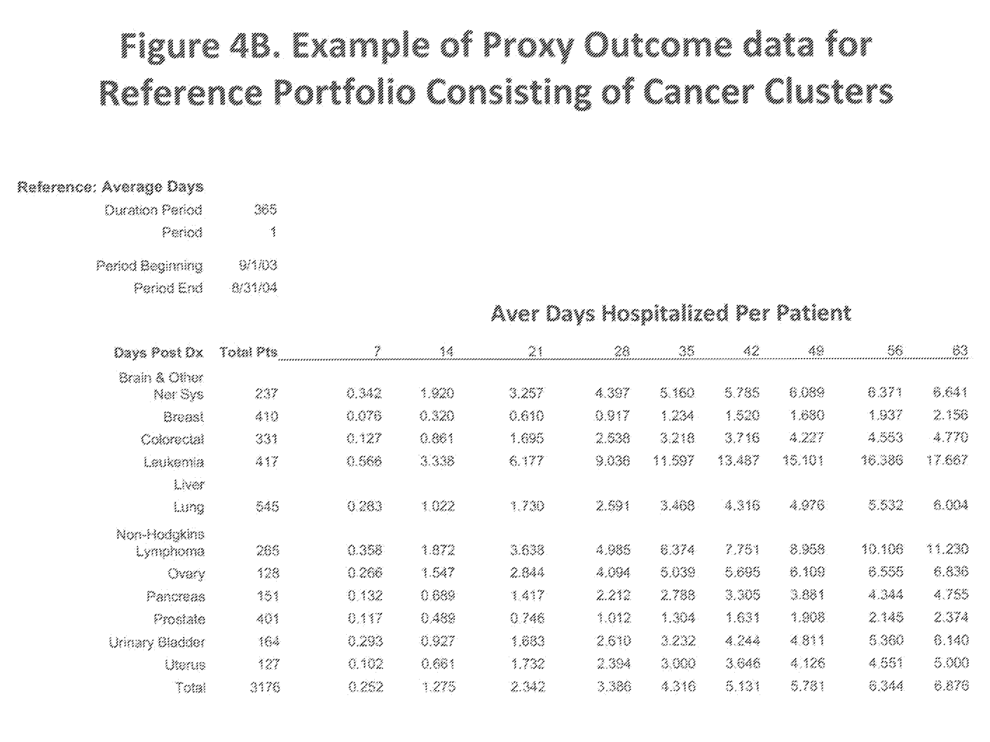

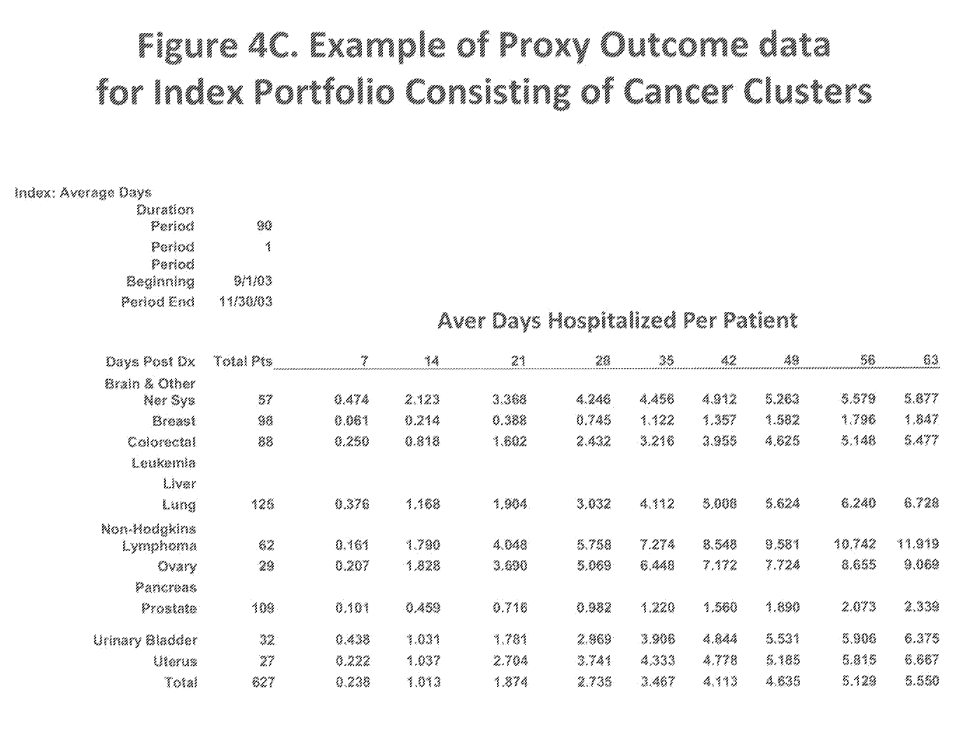

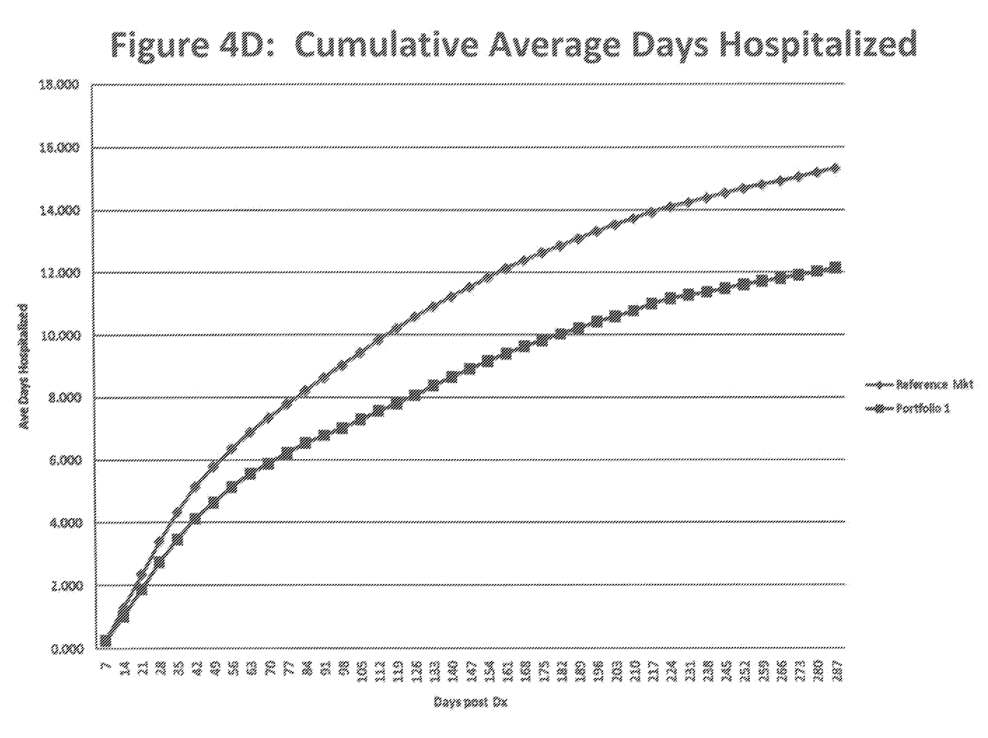

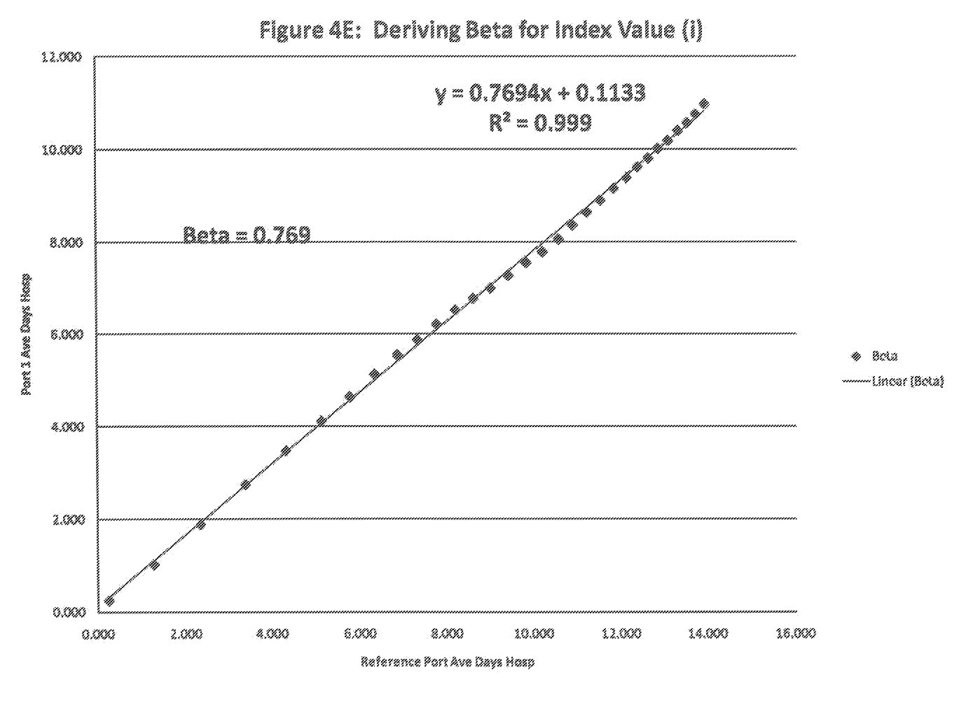

One approach to obtaining the data required for both outcome data as well as the proxy outcome data is to look “back”. That is to say, if one is interested in data for a time period (tₙ) that is equal to 12 months accumulated proxy outcome from previous 12 months is collected. FIG. 4A provides an illustration of “looking-back” to collect both outcome data and proxy outcome data for time period (t₁). Each index value represents the total accumulated outcomes for the previous 12 months. As is illustrated by the top line in FIG. 4A, the index value for time period(t₁) was determined by accumulating 12 month outcome data for all the patients admitted (luring the one month period (“enrollment period”) 12 months prior to the index value period of interest. It should be understood that the enrollment period can be as short as 1 day or as long as 1 year.

The total accumulated amount of the outcome and proxy outcome data is then reported for the time period (t₁) as the unadjusted index value. For the index value for time period (t₂), the same process is undertaken. (It should be understood that the enrollment period can be as short as 1 day or as long as 1 year or more.)

Obtaining the value for the proxy outcome follows a similar process. The proxy outcome data will be collected in an equivalent fashion to the outcome data being collected for the market portfolio and cluster portfolio. That is to say that enrollment period and collection period for the data will mirror the enrollment period and collection period for the market portfolio and cluster portfolio. However, unlike the market portfolio and cluster portfolio, the time period in which proxy outcome data is set. The total proxy outcome data for Time Period (t₀) typically consists of the cumulative values over the time periods intervals (t₁-t₀) over the time period (t₀). If the proxy outcome data is collected on a weekly basis, then there would be 52 data points for a time period (t₀) that accumulated data over a 12 month period.

FIGS. 4B and 4C each provide an example, for both the reference portfolio and the index portfolio respectively, of a portion part of the unadjusted proxy outcome data (e.g., average total days hospitalized per patient up to day 63) having clusters consisting of different types of cancers. As is shown in FIGS. 4B and C, with each time period interval (t₁-t₀) or (t₁-tₙ)), the proxy outcome data (e.g., average total days hospitalized per patient) accumulates.

The third step in the general approach of this disclosure is to determine the Beta for each index portfolios (healthcare cluster portfolios and market portfolio) for each time period (tₙ) (70).

The Beta by definition is the systematic risk that is estimated by comparing the correlated relative volatility of the cumulative proxy outcomes between the cluster portfolio and the reference portfolio using the following relationship for Beta:

β(tₙ)=Cov(rₐ,rₚ)(tₙ)/Var(rₚ)(tₙ)

where rₐ is the rate of change of the index portfolio outcome or proxy outcome, and rₚ is the rate of change of the reference portfolio outcome or proxy outcome, wherein the variables are determined by calculating a linear regression line of the cumulative outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

In practice, there is number of potential ways to calculate or estimate the Beta. For example, as illustrated in FIG. 4D, a proxy outcome curve for the index portfolio can be constructed from the accumulation of the proxy outcome data for a time period intervals (t₁-tₙ) for the defined time period (tₙ). For the Reference Portfolio, a proxy outcome curve is constructed from the accumulation of the proxy outcome data for the equivalent time period intervals (t₁-t₀). While the proxy outcome curve for the portfolio index changes with each time period (tₙ), the proxy outcome curve is set at a predefined time period (t₀) and does not change (except in rare periodic situations). With each new time period (tₙ), the new index portfolio proxy outcome curve is compared to the same reference portfolio proxy outcome curve established at time period (t₀).

The Beta may be estimated by comparing the specific healthcare group's proxy outcomes for the time period intervals (t₁-tₙ) that composed the time period (tₙ) to the reference portfolio's outcomes for the equivalent time period intervals (t₁-t₀) using linear regression. The slope of this linear regression is the beta used to risk-adjust the index value for time period (tₙ). FIG. 4E is a graphical representation of the line generated by linear regression of the proxy outcomes for the reference portfolio and the index portfolio.

For some circumstances, the systematic risk, or beta, can be approximated by comparing directly the proxy outcome summation value of the index portfolio at a time period (tₙ) to the proxy outcome summation values of the reference portfolio at a time period (t₀). For example, an approximation of the beta can be calculated by dividing the proxy outcome summation value of the index portfolio at a time period (tₙ) to the proxy outcome summation values of the reference portfolio at a time period (t₀).

The fourth step in the general approach of this invention is to risk-adjust for the patient-mix index value (80) using the beta for time period (tₙ). The risk-adjusted index value is calculated by dividing the index value with the Beta.

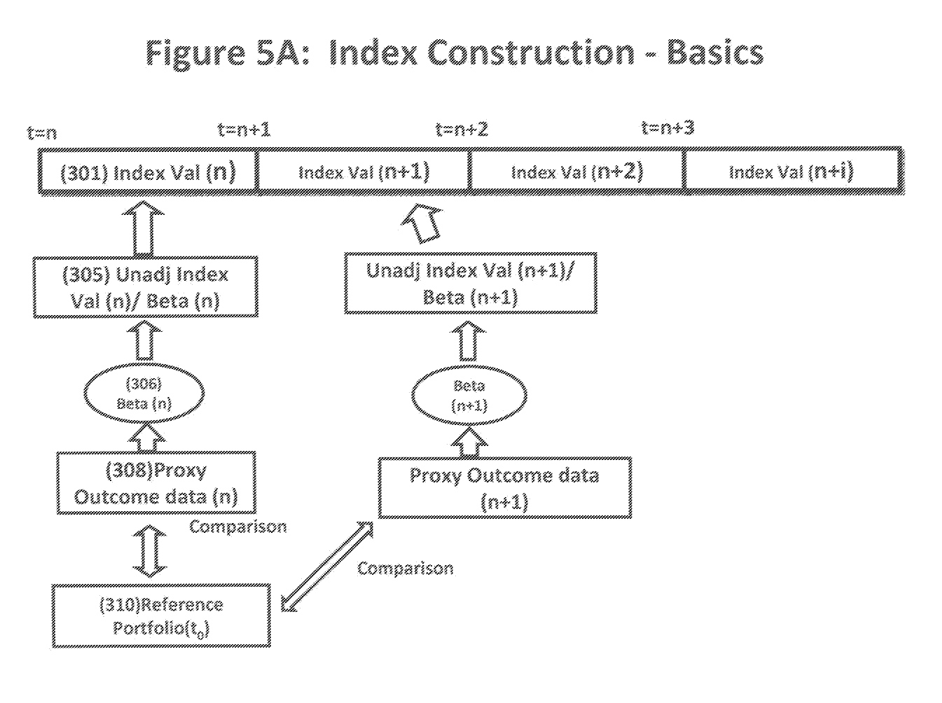

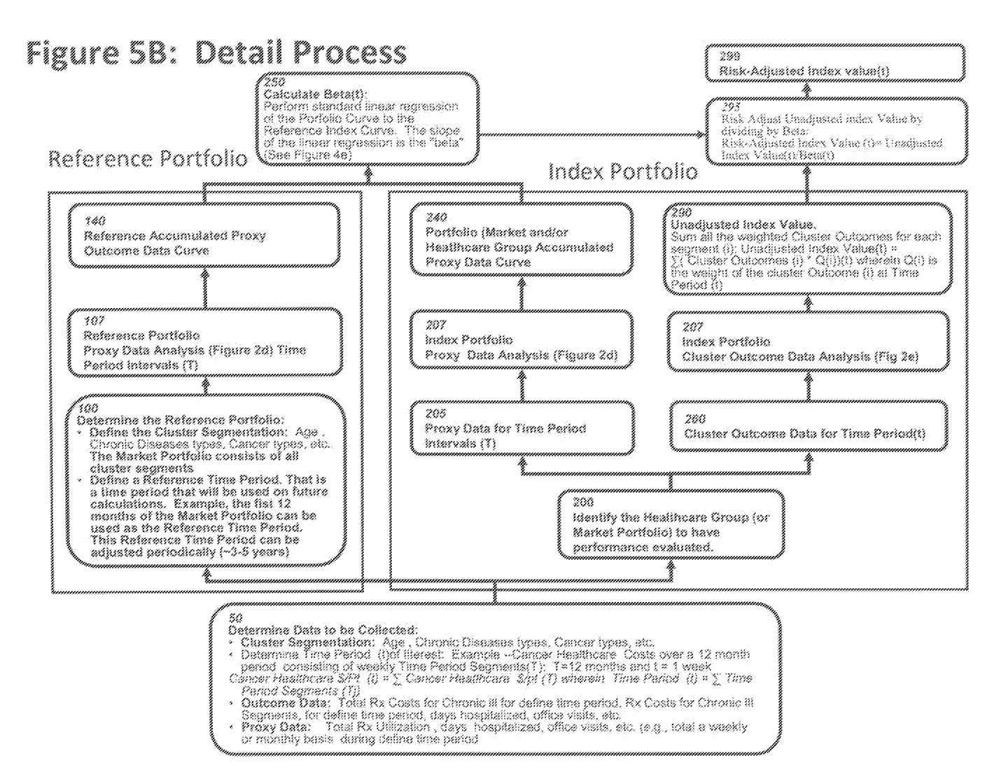

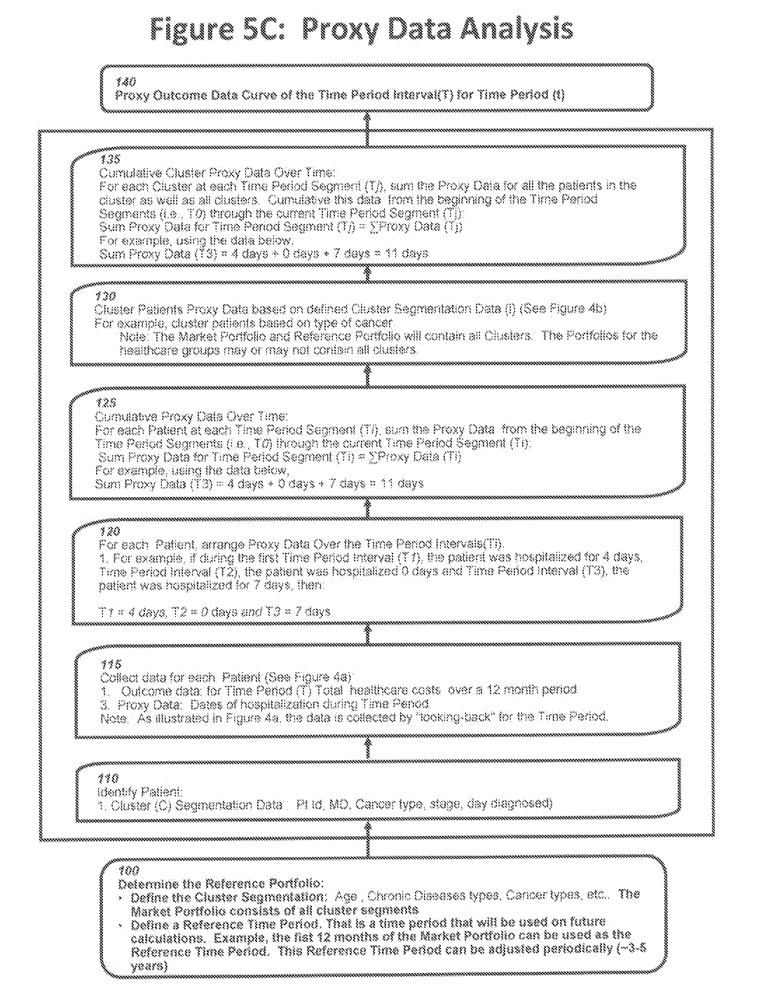

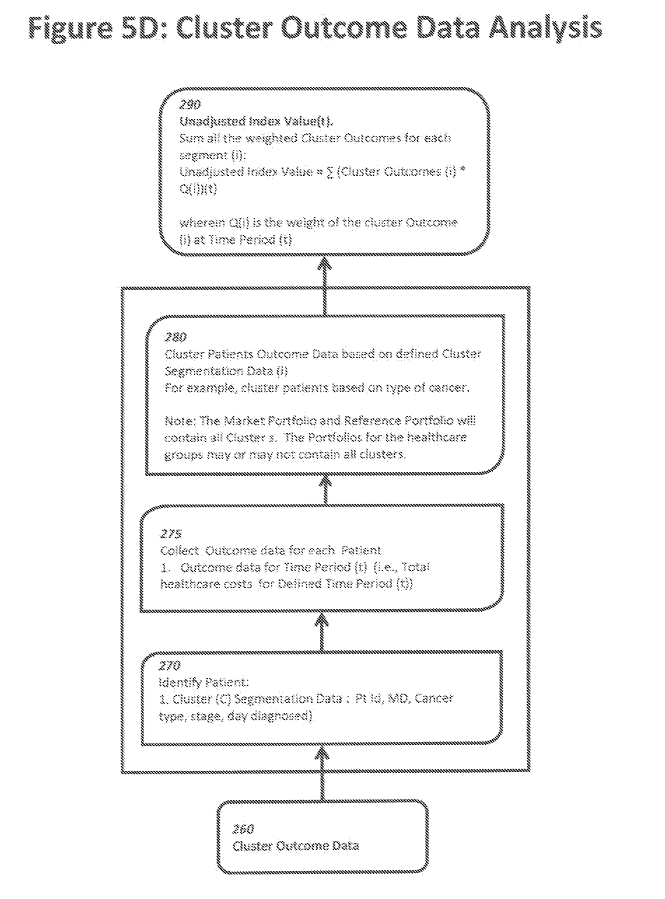

The general approach to risk adjusting the index values for a index is illustrated in FIG. 5A and include the following steps:

Constructing an index for the cluster portfolio consisting of risk-adjusted index values (301) for each time period (tₙ);

Wherein, the risk adjusted index value (301) is derived by dividing the unadjusted index values (305) by a systematic risk factor beta (306);

Wherein, the beta (306) may be estimated by comparing the cluster portfolio (308) proxy outcomes for the time period intervals (t₁-tₙ) that compose the time period (tₙ) to the reference portfolio's proxy outcomes for the equivalent time period intervals (t₁-t₀);

Wherein the comparison of the proxy outcomes is accomplished through linear regression, division or other means to obtain a risk-adjustment beta.

The details of constructing one embodiment of an index consisting of risk-adjusted index value for a specified time period (tₙ) are shown schematically in FIGS. 5B, 5C and 5D.

The final step in the general approach to risk adjusting the index values for patient-mix is to compare risk-adjusted index values (90) directly to other risk-adjusted portfolios or relative to a risk-adjusted benchmark or market index.

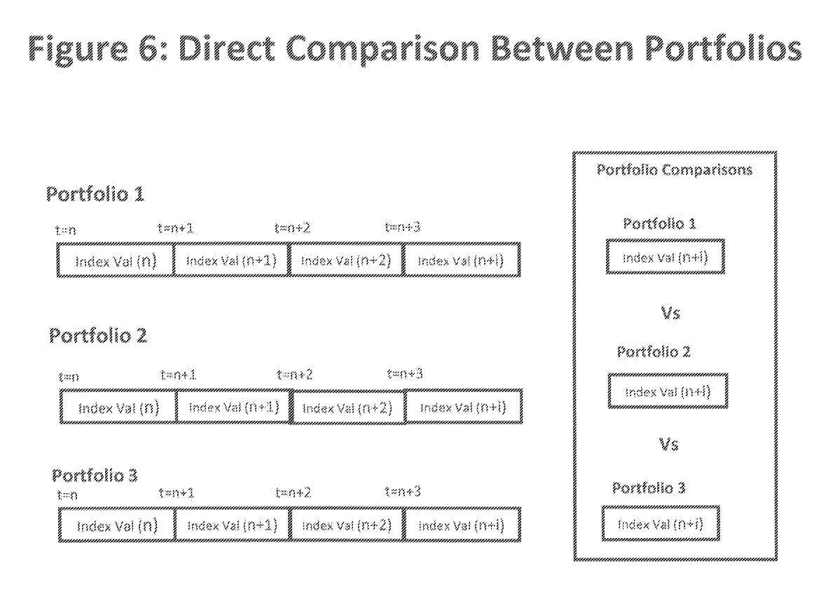

As illustrated in FIG. 6, two or more cluster portfolios can be compared directly by a process that includes:

a. Constructing an index of performance outcomes for each portfolio of clusters wherein each index of outcomes comprises at least one index value wherein cach index value is a performance outcome that has been risk-adjusted to reflect the varying composition of the clusters for each portfolio relative to a set reference portfolio utilizing the following equation:

Index Value(tₙ)=(Σcluster outcome(i)*Q(i))(tₙ)/(Beta(tₙ))

Wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by correlating the relative volatility of the cumulative proxy outcomes between the cluster portfolio and the reference portfolio; and

b. Comparing the risk-adjusted index values for each cluster portfolio relative to the other cluster portfolio.

The index values can be compared, then, for each time period (tₙ) or plotted over multiple time periods to identify trends in performance.

To obtain an understanding of performance between groups and obtain an understanding of whether one group is performing better than the other group, comparisons need to be done relative to a market or benchmark index. This disclosure further provides a method of comparing, relative to a market index, groups comprising populations of individuals by comparing performance indexes for each group to a market index wherein each index is an index of outcomes for a portfolio of clusters comprising at least one index value and the index value is risk-adjusted to reflect the varying composition of the clusters for each group.

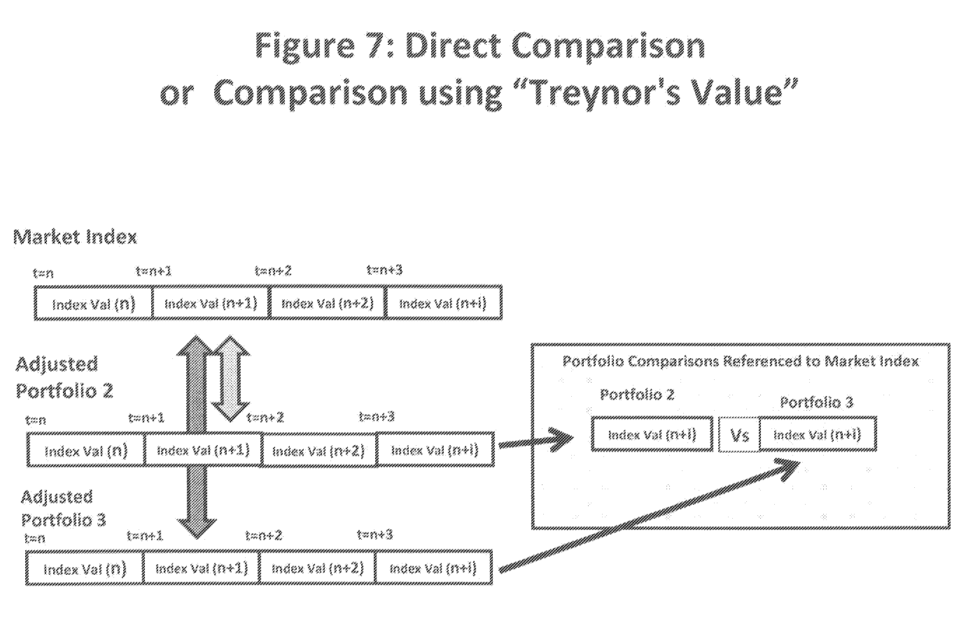

As shown in FIG. 7, the present disclosure provides a method of comparing different portfolios to one another relative to the Market index including:

a. Constructing an index of outcomes for each portfolio of clusters and the market portfolio wherein each index of outcomes comprises at least one index value wherein each index value is a performance outcome that has been risk-adjusted to reflect the varying composition of the clusters for each portfolio relative to a set reference portfolio utilizing the following equation:

Index Value(tₙ)=(Σcluster outcome(i)*Q(i))(tₙ)/(Beta(tₙ))

Wherein, cluster outcome (i) is the outcome value for cluster (i) in the cluster or market portfolio at time (tₙ); Q(i) is the segment weight of cluster (i) in the cluster or market portfolio at time (tₙ); and Beta is the systematic risk at time (tₙ) and the systematic risk is estimated by correlating the relative volatility of the cumulative proxy outcomes between the cluster or market portfolio and the reference portfolio; and

b. Comparing the risk-adjusted index values for each cluster portfolio relative to the risk-adjusted index values for the market index cluster portfolio.

The index values can be compared relative to the index values of the market index, then, for each time point or plotted over multiple time periods to identify trends in performance.

Still further, after having been risk-adjusted for the varying patient-mix, the individual portfolios can be further compared by performing a linear regression analysis of the risk-adjusted portfolio index compared to the risk adjusted market index over multiple time periods (t). The linear regression results in the following equation:

Portfolio Index Value(tₙ)=a+mₚ(Market Index Value(tₙ))

wherein, the “alpha”, or a, is the y intercept from the linear regression equation and represents the distance from the “market line” for each index of cluster portfolios. The a can be used to determine how well each cluster portfolio is being managed. Finally, other measures used in Modern Portfolio Theory such as Sharpe's measure, Jansen's measure, etc. can be used on the risk-adjusted indexes to obtain performance comparisons.

The mₚ, is the slope of the linear regression between the index for the cluster portfolio and the index for the market portfolio over multiple time periods (i.e., months, years, etc.). This slope, mₚ, can be used in the calculation of the Treynor's measure of the portfolios so as to compare the risk-adjusted performance of the two portfolios over multiple time periods (tₙ) relative to the risk-adjusted market index. Treynor's measure is a well known measure in finance and the approach is used here to determine performance or cluster portfolios relative to a market portfolio and uses the equation:

Treynors=(Index Valueₚ/mₚ)

where Index Valueₚ=risk adjusted index value of the cluster portfolio for time Period (tₙ)

### Uses

An aspect of the present disclosure is the manufacture, adaptation and/or use of electronic equipment to generate the indexes and to compare groups comprising populations of individuals by comparing performance indexes for each group to a market index that is generated according to this disclosure. The indexes can be used to develop improved pay-for-performance programs, healthcare plans, drug reimbursement programs, etc., for use by healthcare providers and/or payors by risk adjusting the performance of said healthcare provider to reflect the diversity of its patient population. The disclosure also finds application in the field of education for evaluation of the performance of teachers, schools and school systems and other institutions for which model portfolios can be constructed to provide an index. Furthermore, the indexes of this disclosure can be used as a means to forecast future values and establish financial triggers for financial instruments and insurance linked securities.

The following examples are included to demonstrate preferred embodiments of the disclosure. However, those of skill in the art should, in light of the present disclosure, appreciate that many changes can be made in the specific embodiments which are disclosed and still obtain a like or similar result without departing from the spirit and scope of the invention.

### Example 1

### A Healthcare Index

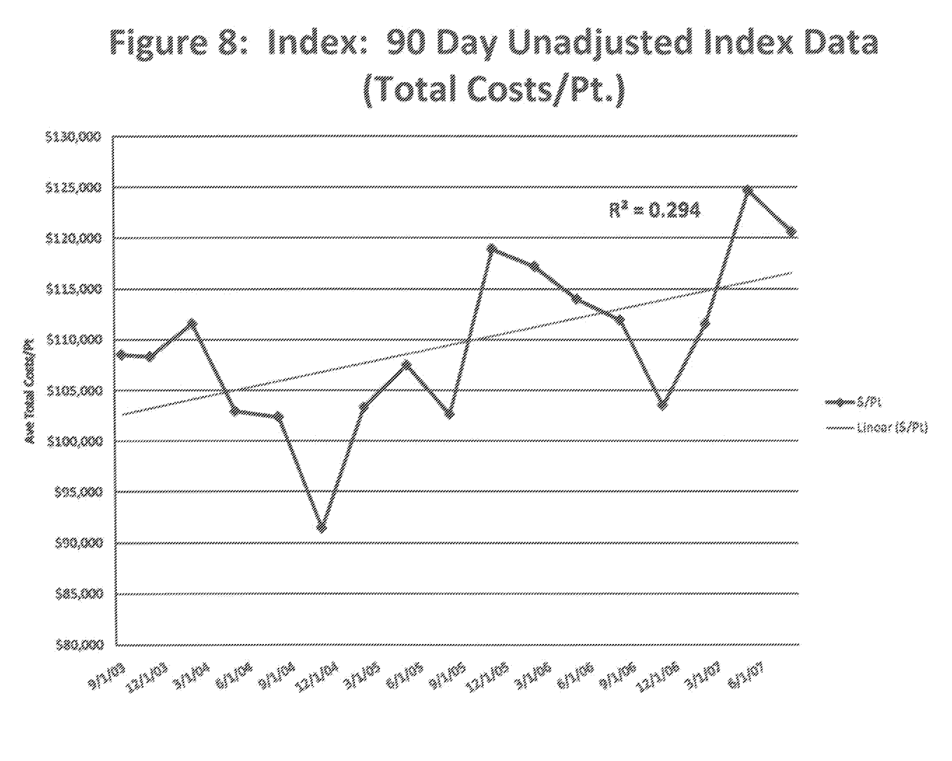

As an example of a preferred embodiment, an index of cancer healthcare (“CHC Index”) was constructed. FIG. 8 illustrates the 90 day unadjusted index values for performance outcome data as defined as the average total healthcare cost per patient, for patients seen at a medical center for inpatient treatment of their cancers. (Also shown in FIG. 8 is a trend line for the unadjusted index data)

The index was constructed for a portfolio of patients consisting of 11 clusters. The clusters were defined as a grouping of patients diagnosed with one of the following cancers: uterine, urinary bladder, prostatic, pancreatic, ovarian, non-Hodgkin's lymphoma, lung, leukemia, colorectal, breast, brain & other nervous system cancers. The Unadjusted Index Value consists of the sum of all weighted Cluster Outcomes for each cluster segment as follows:

Unadjusted Index Value(tₙ)=Σ(Cluster Outcome(i)*Q(i))(tₙ)

Wherein, cluster outcome (i) is the outcome value for cluster (i) in the cluster portfolio for the healthcare group for time period (tₙ).

The unadjusted index values are shown for 90 day time periods (tₙ). Each index value represents the total accumulated outcomes for the previous 12 months. Using an approach similar to what was illustrated in FIG. 4A, the index value for time period(tₙ) was determined by accumulating 12 month outcome data for all the patients admitted during the three month period (“enrollment period”) 12 months prior to the index value period of interest.

As can be seen in FIG. 8, the 90 day unadjusted index data is quite variable. Over a period of approximately 4 years, the index appears to trend upwards. However, the variability as denoted by the correlation (R²) is very low (0.294) making the utility of the index less than optimal.

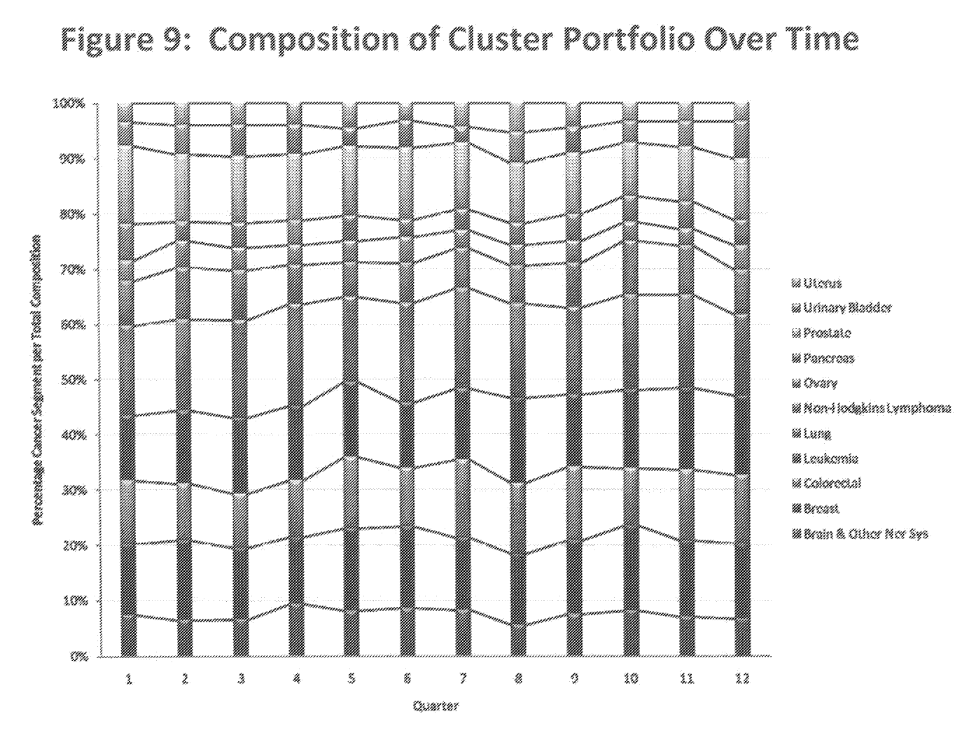

A major reason for the variability of the unadjusted index values can be seen by examining the composition of the portfolio in terms of cluster composition (i.e., patient-mix) for each index value over the entire time period. FIG. 9 illustrates the variability of the cluster sizes within the cluster portfolio over time. As would be expected, the size and morbidity, of each cluster within a portfolio varies over time. In this example the number of patient-mix for each cluster that composes the cluster portfolio changes in an unpredictable manner. Thus, the variability in the size and morbidity of each cluster adds to the variability of index values overtime.

It should be noted that if the variability of the index values were solely caused by the variability in the size contribution of the different clusters over time, this variability could be easily rectified by adjusting for the varying cluster sizes. However, in addition to varying size, each cluster has a variability component caused by the systematic risk as a result of having a new population of patients with different severity of disease for each time point. In the case of a healthcare index, this systematic risk can be the measure of morbidity of the patients that compose the cluster. For example, in one time period, the patients that compose one cancer cluster may have early stage cancer and in another time period they may have late stage cancer. Even if the cluster sizes were the same size between the two time periods, the average total cost/pt will be much greater for the cluster with the late stage cancer because the patients are sicker (i.e., have a higher morbidity).

Thus, up to now, the use of indexes for portfolios having clusters with constantly changing patient-mix compositions has been limited because of the inability to easily risk-adjust the indexes to the varying patient-mix compositions in terms of both size and morbidity. The present disclosure provides methods for accounting for morbidity by comparison to a reference portfolio to determine the systematic risk, or beta. The systematic risk is estimated by correlating the relative volatility of the cumulative proxy outcomes between the cluster portfolio and the reference portfolio.

Each specific unadjusted index value (tₙ), as shown in FIG. 8 is risk-adjusted by dividing the estimated Beta for each time period (tₙ) as follows:

Risk-Adjusted Index Value(tₙ)=Unadjusted Index Value(tₙ)/Beta (tₙ) Wherein the Beta is the systematic risk at time (tₙ) and the systematic risk is estimated by correlating the relative volatility of the cumulative proxy outcomes between the cluster portfolio and the reference portfolio.

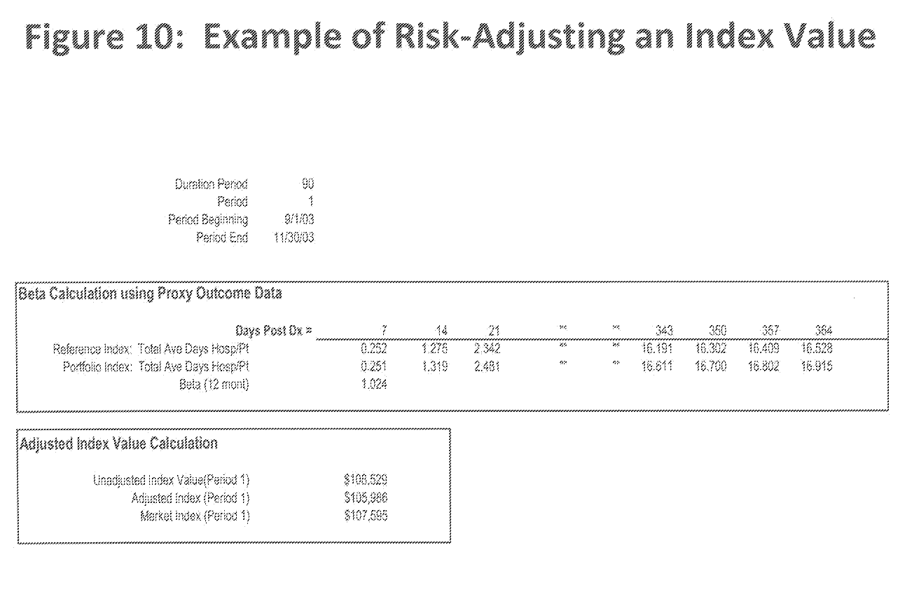

FIG. 10 provides an example of one approach to estimating the Beta for first time period (e.g., Sep. 1, 2003) for the index portfolio as seen in FIG. 8. The proxy outcome used for both the index portfolio and the reference portfolio for this example is the total average days hospitalized per patient. This proxy outcome exhibits a mean-variance relationship with the morbidity of the cancer patients in that cancers with higher morbidity tend to have an increased number of days hospitalized (i.e., lung cancer exhibit higher average total days hospitalized than breast cancer). FIG. 10 provides a sampling of the proxy outcome data for both the reference portfolio and the index portfolio from day 7 through day 364. Also shown is the estimated Beta (1.024). The Beta was estimated by taking a linear regression of the proxy outcome data for the reference portfolio and the index portfolio between days 7 through 364.

/As shown in FIG. 10 the unadjusted index value $108,529 when divided by the Beta (1.024) equals the adjusted index value of $105,986 for the time period (tₙ=“9.1.03”). For each 90 day time period (tₙ), the same procedure is undertaken to obtain a risk adjusted index value for that time period.

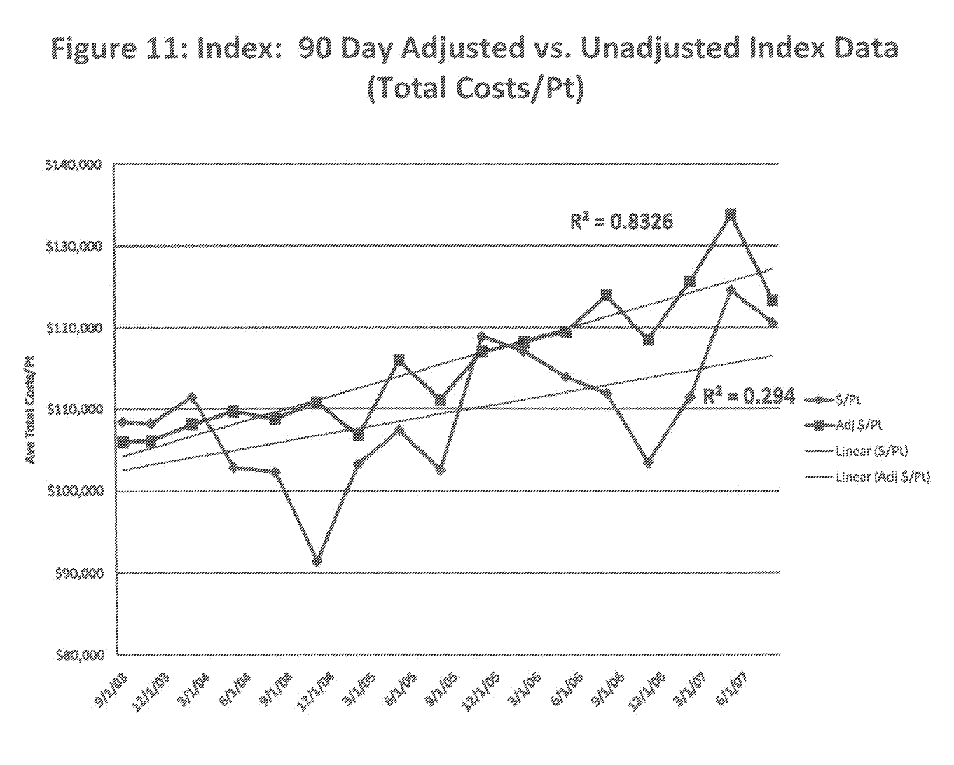

FIG. 11 illustrates the 90 day adjusted versus unadjusted indexes for the cluster portfolio of this example over an approximately four year period. The first index line, labeled $/Pt is the unadjusted index values for the cluster portfolio shown in FIG. 8. The second index line labeled Adj $/Pt is the patient-mix adjusted index for the same cluster portfolio. The index has been risk adjusted to reflect both the varying cluster proportion and morbidity for the index portfolio over time. As is seen, the patient-mix-adjusted index has significantly improved correlation (R²=0.8326) over time as a result of minimizing the variability secondary to change in cluster proportion and morbidity over time.

### Example 2

### Comparing Different Healthcare Groups

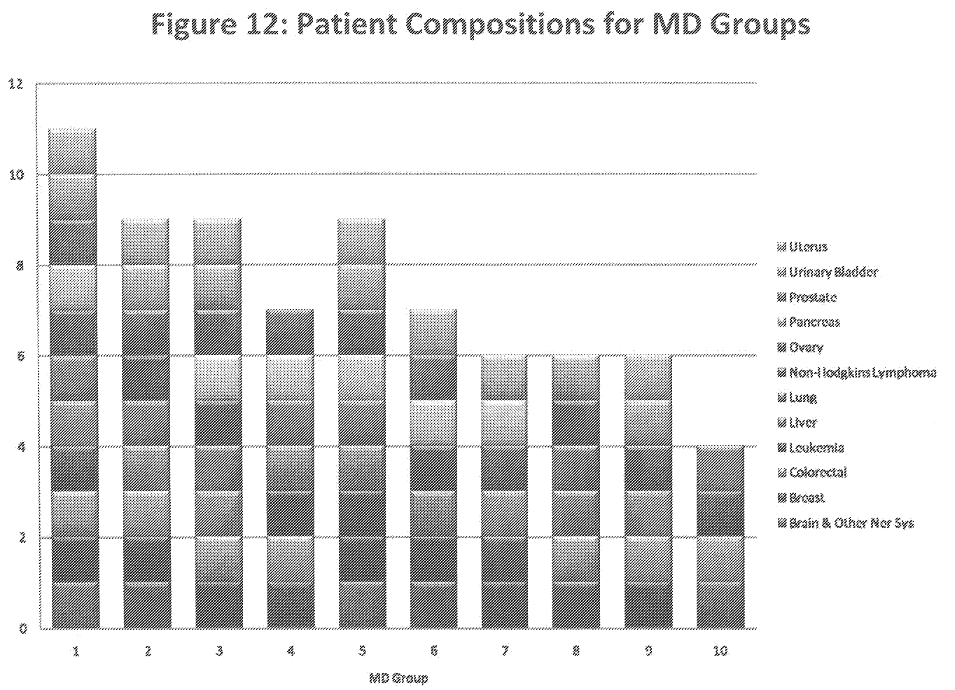

In order to demonstrate an additional preferred embodiment, ten hypothetical oncology groups (i.e. MD groups) were compared for performance to treat patients by each MD group as measured by average total pharmaceutical costs per patient. Each MD group portfolio is composed of clusters consisting of patients diagnosed with different cancers. FIG. 12 is a bar graph showing the cluster composition for each MD Group. (Note, MD Group 11 has the same patient-mix as MD Group 1. However, MD Group 11's costs have been increased for the treatment of patients with leukemia and lung cancer).

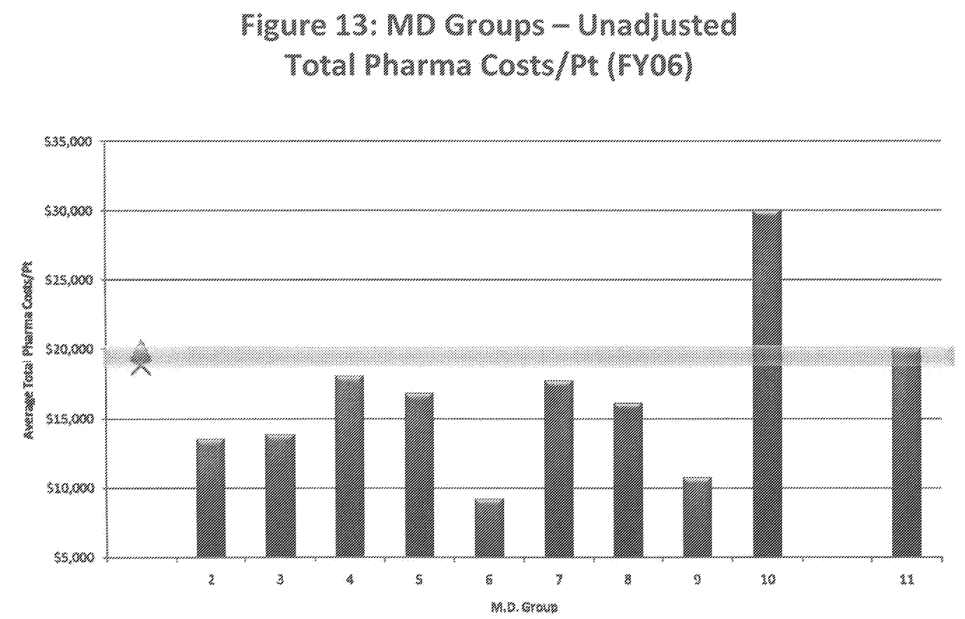

FIG. 13 shows the average total pharmaceutical costs per patient for the ten hypothetical MD Groups for a single Time Period (tₙ). Additionally, FIG. 13 also shows the market portfolio index (plus/minus one standard deviation) as a shaded band. As can be seen in this figure, making comparisons between MD Groups having portfolios with varying patient-mix is difficult. Furthermore, which MD Groups have costs that are higher or lower compared to the market portfolio is not obvious given the varying patient-mix in the different portfolios.

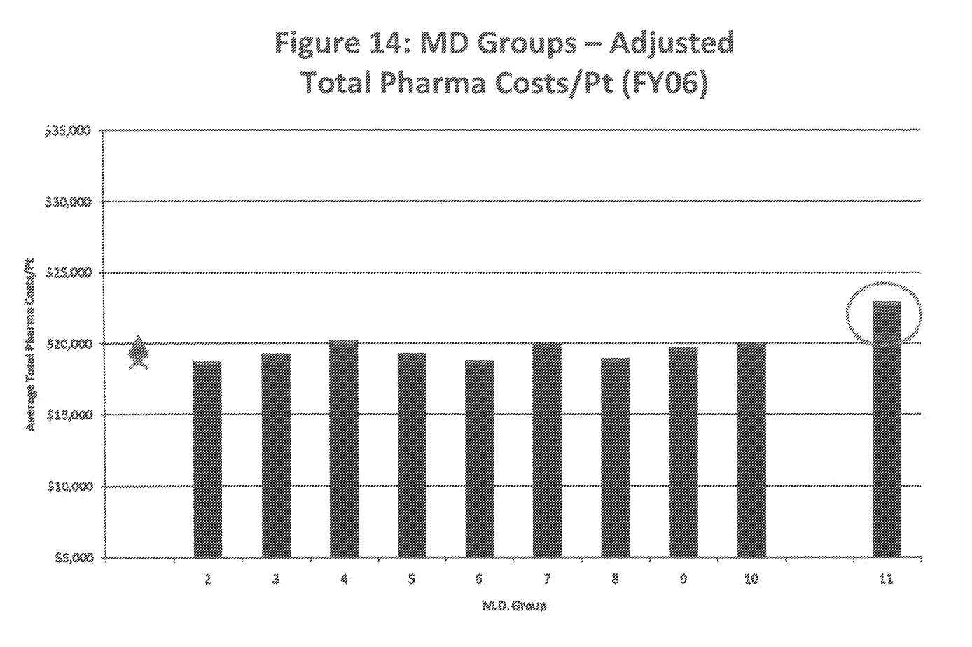

Using the methods disclosed herein, all ten MD Groups with different portfolios were risk-adjusted to reflect their variation in the patient population and morbidity (i.e., patient-mix) of each MD Groups' portfolio. FIG. 14 provides the results of the risk-adjusted average total pharmaceutical costs per patient. As can be seen, except for MD Group 11, all MD Groups' costs are close to, or within the expected costs as seen by the market portfolio (shaded hand). MD Group 11 has costs that are substantially higher than the Market Index. The MD Group with higher costs (MD Group 11) now appears obviously different when compared to the other MD Groups. Thus, the use of the systems and methods of this disclosure allow for the direct comparison of different healthcare providers consisting of cluster portfolios with different patient-mixes. Regardless of the patient-mix, healthcare groups with non-conforming performance can be identified and engaged leading to costs savings and improved healthcare for the patients.

### Additional Examples

This disclosure now permits the assessment of portfolios composed of clusters of varying patient-mix populations using techniques analogous to financial assessment (i.e. assessment of risk, predicted returns, price forecast, price Options, etc.).

For example, it is now feasible to evaluate the level and efficiency of care in pay-for-performance programs in which the performance of healthcare providers having different patient populations (i.e., patients with different diseases coming from different geographic, ethnic, economic and educational influences) can be evaluated in a way that adjust for the diversity of the respective patient populations.

Furthermore, this disclosure provides indexes that can be used in systems and methods for developing improved health insurance programs for use by healthcare providers, by normalizing the patient population for a healthcare provider relative to other healthcare providers. Likewise, improved drug reimbursement programs are now achievable in light of this disclosure for use by healthcare providers by comparing the patient population for a healthcare provider relative to other healthcare providers utilizing the systematic risk for a performance index of the healthcare provider patient population.

Systems and devices disclosed herein can also be used to construct indexes as a means to forecast future values. For example, forecasting a future cost or price per patient for the cluster portfolio (i) consisting of a cancer healthcare center (i) can be accomplished using standard future pricing techniques. Pricing for the cancer center cluster portfolio (i) is dependent on rate of growth and variability of the growth of the market portfolio as follows:

Pᵢ=P_{MKT}*m*e^{rM}

and, r=μ*Δt+σ*ε√Δt

where Pᵢ=Future price per patient for cluster portfolio (i)

P_{MKT}=Current price per patient of market cluster portfolio

m=the slope derived from the linear regression between the index of the cluster portfolio and the index of the market portfolio over those multiple time periods (tₙ)

r=growth rate

μ=trend for Market Index

σ=volatility of Market index

ε=normal random variable with a mean of 0 and a distribution of +/−1

(It should be noted, that if forecasting price using the above equation does not use a market portfolio, but only uses the cancer center cluster portfolio, then m is equal to 1; and μ=growth rate for the cancer center cluster portfolio; and σ=volatility of cancer center cluster portfolio.)

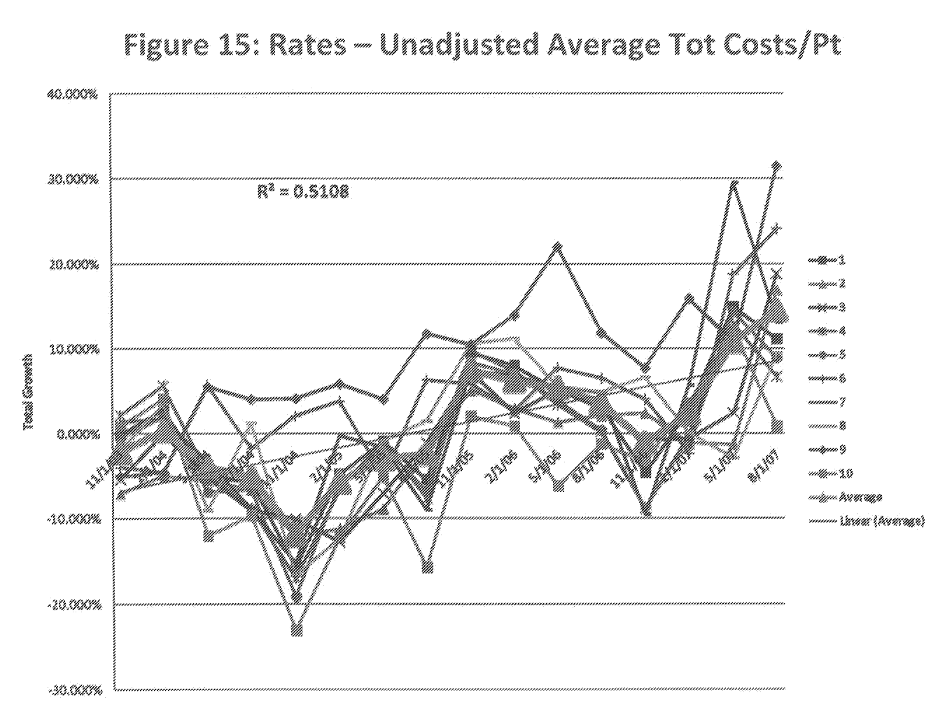

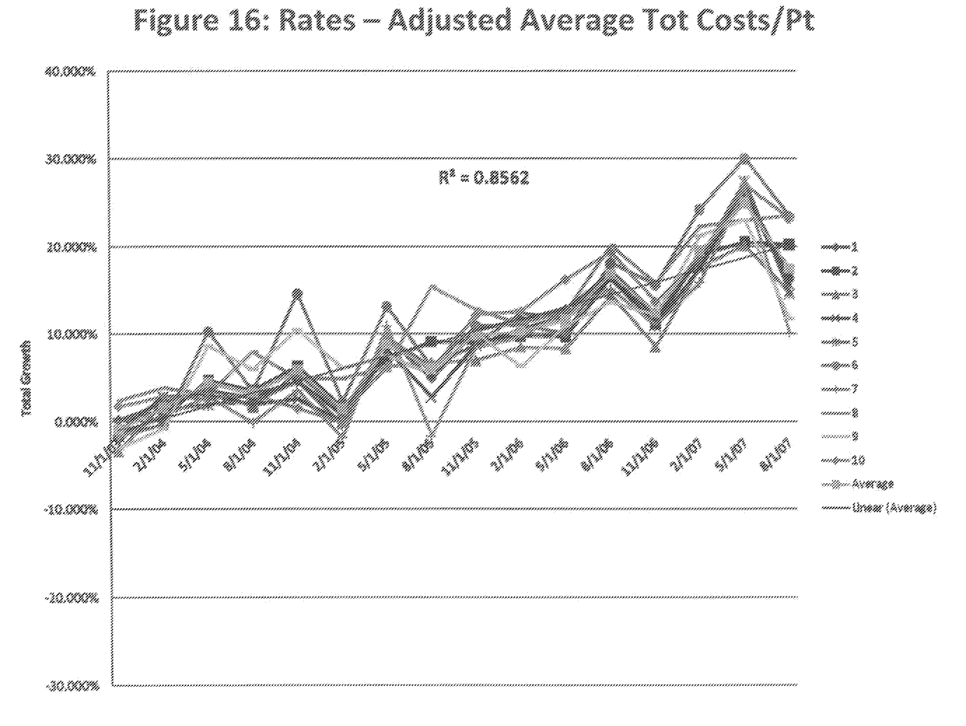

FIG. 15 illustrates the change in average total costs per patient over a four year period of the ten hypothetical MD groups from Example 2 as well as the average change in average total costs per patient over a four year period. As can be seen, determining the growth rate using the unadjusted index values is less than optimal because of the great volatility of the portfolios (e.g., correlation for an average portfolio being 0.51). FIG. 16 illustrates change in average total costs per patient over a four year period of the same ten hypothetical MD groups but after being risk adjusted for the patient-mix. As can be seen, the volatility is significantly improved (correlation of 0.85). As a result, determining a growth rate is now feasible. The growth rate and the variability can be used to forecast the future outcome (e.g., Tot costs/pt) for average of the ten MD groups.

The development of indexes as disclosed herein can be used as a financial trigger for financial instruments and insurance linked securities. For example, there exists no cancer healthcare index or other healthcare index that can be used as trigger for healthcare insurance linked securities (ILS) products. An opportunity now exists for the creation of an efficient and reliable healthcare cost index that can be used as triggers in the development of new healthcare ILS products. Access to healthcare cost index triggers increases the flexibility of ILS solutions for the healthcare industry and helps create a market for healthcare insurance based industry loss warranties, bonds, swaps, options, etc.

Additionally, in addition to providing a reliable healthcare cost index that can be used as triggers in the development of new healthcare ILS products, the Indexes of this disclosure can be designed to allow healthcare market participants (insurers, reinsurers, investors, healthcare providers, etc.) to measure, manage, and trade exposure to healthcare cost risks (e.g., revenue shortfall and expense exposure) associated in a standardized, transparent, and real-time manner. As way of illustration, healthcare providers have to plan and budget future revenues. Any decline in their expected cash flow from a decline in the cancer healthcare costs will affect them adversely. If an Index-linked insurance derivative product such as a future contract were available, the healthcare providers would be natural sellers or shorts for this ILS product. On the other hand, healthcare insurers of all kinds (including managed care firms, indemnity companies, and self-insured employers) quote a fixed premium for the healthcare benefit. Their business suffers when cancer healthcare costs, as reflected in the Index rise. As a result, any healthcare insurer would be a natural buyer or long for this ILS product.

Finally, in addition to providing a reliable healthcare cost index that can be used as triggers in the development of new healthcare performance comparisons, the methods and processes for developing Indexes of this disclosure can be designed to allow other service providers to compare performances. For example, the indexes of this disclosure can be used by a school, a school system, an educational department in a school system or a teacher to evaluate performance outcomes that are selected from student grades in a course, student grades on an exam, number of disciplinary actions, and student graduation rate.

While particular embodiments of the invention and method steps of the invention have been described herein in terms of preferred embodiments, additional alternatives not specifically disclosed but known in the art are intended to fall within the scope of the disclosure.

Thus, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. An electronic system adapted to provide a performance rating index for a healthcare service comprising:
a user interface comprising a processor, a monitor and a user input device;
an electronic connection to one or more memory storage devices, wherein at least one of the memory storage devices comprises an imprinted computer readable database, the database comprising:
an index data base comprising at least one numerical indicator of health care performance outcomes and proxy outcomes for a plurality of patients at a plurality of selected time points, wherein the patients are grouped into one or more portfolios and the patients within each portfolio are each assigned to one of a plurality of clusters;
computer readable instructions to average the outcomes and proxy outcomes for each cluster at each time point to produce a cluster outcome and cluster proxy outcome, and to add the average at each time point (t₁-tₙ) to the cumulative average from the previous time point;
and wherein at least one of the memory storage devices comprises an imprinted, computer readable database, the database comprising:
a reference database comprising at least one proxy outcome that is the same proxy outcome as at least one proxy outcome in the index database for the equivalent time points as in the index database, wherein the proxy outcome at each time point (t₁-t₀) is added to the cumulative proxy outcome from the previous time point;
a computer readable memory device electronically connected to the processor and adapted to have imprinted computer readable instructions for calculation of the index using the following relationship:
Index Value(tₙ)=(Σcluster outcome(i)*Q(i))(tₙ)/(Beta(tₙ))
Wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by correlating the relative volatility of the cumulative proxy outcomes between the cluster portfolio and the reference portfolio.

2. The system of claim 1, wherein the outcomes and proxy outcomes are' the same numerical indicator of healthcare performance.

3. The system of claim 1, wherein the proxy outcomes have a mean-variance relationship to a defined macro-factor of the cluster or plurality of clusters for each portfolio.

4. The system of claim 1, wherein the outcomes are selected from total cost per patient, number of emergency room visits, complication incidents, mortality, survival duration, quality of life, hospitalizations, office visits, number of pharmaceutical therapies, remission duration, radiation treatments, diagnostic studies and laboratory measurements.

5. The system of claim 1, wherein the proxy outcomes are selected from total number of days in hospital, total number of outpatient visits, total number of radiation treatments, total number of chemotherapy treatments, total monthly prescriptions, total monthly prescription expenditures.

6. The system of claim 1, wherein the patients are grouped into clusters by common diagnosed conditions.

7. The system of claim 6, wherein the diagnosed conditions are types of cancer.

8. The system of claim 6, wherein the diagnosed conditions are stages of cancer.

9. The system of claim 6, wherein the diagnosed conditions are types and stages of cancer.

10. The system of claim 7, wherein the diagnosed cancers comprise cancers of the uterus, urinary bladder, prostate, pancreas, ovary, non-Hodgkin's lymphoma, lung, leukemia, colorectal, breast, brain, or nervous system.

11. The system of claim 1, wherein the processor is electronically connected to a computer readable memory device adapted to provide computer readable instructions for calculation of the Beta at time (tₙ) using the following relationship for Beta:
β(tₙ)=Cov(rₐ,rₚ)(tₙ)/Var(rₚ)(tₙ)
where rₐ is the rate of change of the index portfolio proxy outcome, and rₚ is the rate of change of the reference portfolio proxy outcome, wherein the variables are determined by calculating a linear regression line of the cumulative outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

12. The system of claim 11, wherein the reference portfolio comprises a sufficient number of patients in each cluster that the specific risk of the individuals is statistically insignificant.

13. The system of claim 1, wherein the database includes patients with a first diagnosis within a selected time period prior to index time point t₁, and wherein the database includes data from a defined period t₁ to tₙ.

14. The system of claim 13, wherein the defined period (n) is 12 months.

15. The system of claim 13, wherein the selected time period prior to index point t₁ is 3 months.

16. An electronic system for providing an index for a healthcare service comprising:
a server computer connectable to a user interface;
wherein the server comprises
an electronic connection to one or more memory storage devices, wherein at least one memory storage device comprises an imprinted computer readable database comprising at least one numerical indicator of health care performance outcomes and proxy outcomes for a plurality of patients assigned to an index portfolio, wherein the patients are grouped into one or more portfolios and the patients within each portfolio are each assigned to one of a plurality of clusters, and wherein the database includes the cumulative average outcome and proxy outcome for each cluster at a plurality of selected time points, and wherein at least one memory storage device comprises an imprinted, computer readable database comprising cumulative average proxy outcomes for a plurality of clusters of a reference portfolio at the equivalent time points as the index portfolio data;
a computer readable memory device connected to or contained in the server and adapted to comprise computer readable instructions for calculation of the index using the following relationship:
Index Value(tₙ)=(Σcluster outcome(i)*Q(i))(tₙ)/(Beta(tₙ))
Wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing the cluster portfolio to the reference portfolio.

17. The system of claim 16, wherein the estimation of the systematic risk is made by comparing the correlated relative volatility of the cumulative proxy outcomes between the cluster portfolio and the reference portfolio.

18. The system of claim 16, wherein the estimation of the systematic risk is made by comparing the correlated relative volatility of the cumulative proxy outcomes between the cluster portfolio and the reference portfolio using the following relationship for Beta:
β(tₙ)=Cov(rₙ,rₚ)(tₙ)/Var(rₚ)(tₙ)
where rₐ, is the rate of change of the index portfolio outcome or proxy outcome, and rₚ is the rate of change of the reference portfolio proxy outcome, wherein the variables are determined by calculating a linear regression line of the cumulative proxy outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

19. The system of claim 16, wherein the server is connected to the user interface by an intranet connection.

20. The system of claim 16, wherein the server is connected to the user interface by an internet connection.

21. An article of manufacture comprising:
a computer usable medium having computer readable program code embodied therein for calculating a performance index using the following relationship:
Index Value(tₙ)=(Σcluster outcome(i)*Q(i))(tₙ)/(Beta(tₙ))
Wherein, cluster outcome (i) is the outcome value for cluster (i) in the cluster portfolio at time (tₙ); Q(i) is the segmented weight of cluster (i) in the cluster portfolio at time (tₙ); and Beta is the systematic risk at time (tₙ) and the systematic risk is estimated by comparing the cluster portfolio to the reference portfolio for a defined outcome, measured over a defined time period.

22. The system of claim 21, wherein the estimation of the systematic risk utilizes the correlated relative volatility of the cumulative proxy outcomes between the cluster portfolio and the reference portfolio.

23. A process for evaluating the performance of a service provider comprising:
calculating a performance index at a plurality of time points for the service provider;
risk adjusting the performance indexes by dividing each index by a calculated β derived by comparison of the index to a reference portfolio index; and
comparing the performance index of the service provider to the risk adjusted performance index of a model portfolio or to the risk adjusted index of another index portfolio;
wherein the process is performed on an electronic system comprising:
a user interface comprising a processor, a monitor and a user input device;
an electronic connection to one or more memory storage devices, wherein at least one of the memory storage devices comprises an imprinted computer readable database, the database comprising:
an index data base comprising at least one numerical indicator of health care performance outcomes and proxy outcomes for a plurality of patients at a plurality of selected time points, wherein the patients are grouped into one or more portfolios and the patients within each portfolio are each assigned to one of a plurality of clusters;
computer readable instructions to average the outcomes and proxy outcomes for each cluster at each time point to produce a cluster outcome and proxy cluster outcome, and to add the average at each time point (t₁-tₙ) to the cumulative average from the previous time point;
and wherein at least one of the memory storage devices comprises an imprinted, computer readable database, the database comprising:
a reference database comprising at least one numerical indicator of health care performance proxy outcome that is the same proxy outcome as at least one proxy outcome in the index database for the equivalent time points as in the index database, wherein the outcome at each time point (t₁-tₙ) is added to the cumulative outcome from the previous time point;
a computer readable memory device electronically connected to the processor and adapted to have imprinted computer readable instructions for calculation of the index using the following relationship:
Index Value(tₙ)=(Σcluster outcome(i)*Q(i))(tₙ)/(Beta(tₙ))
Wherein, cluster outcome (i) is the outcome value for cluster (i) in the cluster portfolio at time (tₙ); Q(i) is the segment weight of cluster (i) in the cluster portfolio a time (tₙ); and Beta is the systematic risk at time (tₙ) and the systematic risk is estimated by comparing the cluster portfolio to the reference portfolio.

24. The system of claim 16, wherein the estimation of the systematic risk is made by comparing the correlated relative volatility of the cumulative proxy outcomes between the cluster portfolio and the reference portfolio.

25. The system of claim 16, wherein the estimation of the systematic risk is made by comparing the correlated relative volatility of the cumulative proxy outcomes between the cluster portfolio and the reference portfolio using the following relationship for Beta:
β(tₙ)=Cov(rₐ,rₚ)(tₙ)/Var(rₚ)(tₙ)
where rₐ is the rate of change of the index portfolio proxy outcome, and rₚ is the rate of change of the reference portfolio proxy outcome, wherein the variables are determined by calculating a linear regression line of the cumulative proxy outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

26. The process of claim 25, wherein the service provider is a medical service provider.

27. The process of claim 26, wherein the medical service provider is a hospital, a physician group, or a physician.

28. The process of claim 26, wherein the service provider is an educational service provider.

29. The process of claim 28, wherein the service provider is a school, a school system, an educational department in a school system or a teacher.

30. The process of claim 28, where performance outcomes are selected from student grades in a course, student grades on an exam, number of disciplinary actions, and student graduation rate.

31. The system of claim 6, wherein the diagnosed conditions comprise different chronic illnesses.

32. The system of claim 31, wherein the different chronic illnesses comprise cardiovascular disease, pulmonary disease, urological disease, endocrinology disease, neurological disease, orthopedic disease, dermatologic disease and gastrointestinal disease.

33. The process of claim 26, wherein the medical service provider is a pharmaceutical benefits management company, a disease management company or a healthcare insurer.

34. The process of claim 26, wherein the medical service provider is the Veterans Administration or a healthcare payor of the U.S. government.

35. An electronic system for providing an index for a healthcare service comprising:
a server computer connectable to a user interface;
wherein the server comprises
an electronic connection to one or more memory storage devices, wherein at least one memory storage device comprises an imprinted computer readable database comprising at least one numerical indicator of health care performance outcomes and proxy outcomes for a plurality of patients assigned to an index portfolio, wherein the patients are grouped into one or more portfolios and the patients within each portfolio are each assigned to one of a plurality of clusters, and wherein the database includes the cumulative average outcome for each cluster at a plurality of selected time points, and wherein at least one memory storage device comprises an imprinted, computer readable database comprising cumulative average outcomes or proxy outcomes for a plurality of clusters of a reference portfolio at the equivalent time points as the index portfolio data;
a computer readable memory device connected to or contained in the server and adapted to comprise computer readable instructions for calculation of the index using the following relationship:
Index Value(tₙ)=cluster outcome(i)*Q(i))(tₙ)/(Beta(tₙ))
Wherein, cluster outcome (i) is the outcome value or proxy outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is determined by calculation of the Beta at time (tₙ) using the following relationship for Beta:
β(tₙ)=Cov(rₐ,rₚ)(tₙ)/Var(rₚ)(tₙ)
where rₐ is the rate of change of the index portfolio proxy outcome, and rₚ is the rate of change of the reference portfolio proxy outcome, wherein the variables are determined by calculating a linear regression line of the cumulative proxy outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

36. A healthcare performance index that has been transformed to be insensitive to the patient-mix so as to be useful for evaluating the performance of a service provider comprising at least one numerical indicator of health care performance outcomes at a plurality of time points that has been risk adjusted for the patient mix by dividing each index value by a calculated β derived by comparison of the index to a reference portfolio index.

37. A healthcare performance index that has been transformed to be insensitive to the patient-mix so as to be useful for evaluating the performance of a service provider comprising at least one numerical indicator of health care performance outcomes at a plurality of time points that has been risk adjusted for the patient mix:
wherein the performance index comprises at least one numerical indicator of health care performance outcomes and proxy outcomes for a plurality of patients at a plurality of selected time points, wherein the patients are grouped into one or more portfolios and the patients within each portfolio are each assigned to one of a plurality of clusters;
wherein said the outcomes and proxy outcomes are averaged for each cluster at each time point to produce a cluster outcome and proxy cluster outcome, and said outcomes are added to the average at each time point (t₁-tₙ) to obtain the cumulative average from the previous time point;
wherein said risk adjusted performance index value is calculated using following relationship:
Index Value(t₀)=(Σcluster outcome(i)*Q(i))(tₙ)/(Beta(tₙ))
wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing the proxy outcomes of the cluster portfolio to the reference portfolio;
wherein said reference portfolio comprises at least one numerical indicator of health care performance proxy outcome that is the same proxy outcome as at least one proxy outcome in the index database for the equivalent time points as in the index database, wherein the outcome at each time point (t₁-t₀) is added to the cumulative outcome from the previous time point.

38. The healthcare performance index of claim 37, wherein the estimation of the systematic risk is by comparing the correlated relative volatility of the cumulative proxy outcomes between the cluster portfolio and the reference portfolio.

39. The healthcare performance index of claim 37, wherein the health care performance outcomes and proxy outcomes are equivalent.

40. The systematic risk of claim 38 is estimated by comparing the correlated relative volatility of the cumulative proxy outcomes between the cluster portfolio and the reference portfolio using the following relationship for Beta:
β(tₙ)=Cov(rₐ,rₚ)(tₙ)/Var(rₚ)(tₙ)
where rₐ is the rate of change of the index portfolio outcome or proxy outcome, and rₚ is the rate of change of the reference portfolio outcome or proxy outcome, wherein the variables are determined by calculating a linear regression line of the cumulative outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).

41. A healthcare performance index that has been transformed to be insensitive to the patient-mix so as to be useful for evaluating the performance of a service provider comprising at least one numerical indicator of health care performance outcomes at a plurality of time points that has been risk adjusted for the patient mix;
wherein the performance index comprises at least one numerical indicator of health care performance outcomes and proxy outcomes for a plurality of patients at a plurality of selected time points, wherein the patients are grouped into one or more portfolios and the patients within each portfolio are each assigned to one of a plurality of clusters;
wherein said the outcomes and proxy outcomes are averaged for each cluster at each time point to produce a cluster outcome and proxy cluster outcome, and said outcomes are added to the average at each time point (t₁-tₙ) to obtain the cumulative average from the previous time point;
wherein said risk adjusted performance index value is calculated using following relationship:
Index Value(tₙ)=(Σcluster outcome(i)*Q(i))(tₙ)/(Beta(tₙ))
wherein, cluster outcome (i) is the outcome value for cluster (i) in the cluster portfolio at time (tₙ); Q(i) is the segment weight of cluster (i) in the cluster portfolio at time (tₙ); and Beta is the systematic risk at time (tₙ) and the systematic risk is estimated by comparing the cluster portfolio to the reference portfolio;
wherein said reference portfolio comprises at least one numerical indicator of health care performance proxy outcome that is the same proxy outcome as at least one proxy outcome in the index database for the equivalent time points as in the index database, wherein the outcome at each time point (t₁-tₙ) is added to the cumulative outcome from the previous time point;
wherein the estimation of the systematic risk is by comparing the correlated relative volatility of the cumulative proxy outcomes between the cluster portfolio and the reference portfolio using the following relationship for Beta:
β(tₙ)=Cov(rₐ,rᵣ)(tₙ)/Var(rₚ)(tₙ)
where rₐ is the rate of change of the index portfolio proxy outcome, and rₚ is the rate of change of the reference portfolio proxy outcome, wherein the variables are determined by calculating a linear regression line of the cumulative outcomes vs. time (t₁-tₙ) for the index portfolio at each time point (tₙ), performing the same calculation for a reference portfolio of clusters at the equivalent time points, and determining the covariance of the two portfolios and the variance of the index portfolio to determine the systematic risk (β) for each time point (tₙ).
